(19) United States
(12) Patent Application Publication
(10) Pub. No.: US 2022/0350116 A1
(43) Pub. Date: Nov. 3, 2022

(54) Optical Imaging Lens Assembly

(71) Applicant: ZHEJIANG SUNNY OPTICS CO.,LTD., Ningbo, Zhejiang (CN)

(72) Inventors: Qiqi LOU, Ningbo, Zhejiang (CN); Jianlai XIE, Ningbo, Zhejiang (CN); Fujian DAI, Ningbo, Zhejiang (CN); Liefeng ZHAO, Ningbo, Zhejiang (CN)

(21) Appl. No.: 17/763,670

(22) PCT Filed: Aug. 20, 2020
(86) PCT No.: PCT/CN2020/110317

§ 371 Date: Mar. 25, 2022

(30) Foreign Application Priority Data
Sep. 27, 2019 (CN) 201910927088.4

(51) Int. Cl. G02B 13/00; G02B 9/60

(52) U.S. Cl. CPC G02B 13/0045; G02B 9/60

(57) ABSTRACT

The disclosure provides an optical imaging lens assembly, which sequentially includes from an object side to an image side along an optical axis: a first lens (L1) with a refractive power; a second lens (L2) with a refractive power, an image-side surface (S4) of the second lens (L2) is a concave surface; a third lens (L3) with a positive refractive power, an object-side surface (S5) of the third lens (L3) is a convex surface; a fourth lens (L4) with a refractive power; and a fifth lens (L5) with a refractive power. TTL is a distance from an object-side surface (S1) of the first lens (L1) to an imaging surface (S13) of the optical imaging lens assembly on the optical axis, EPD is an Entrance Pupil Diameter of the optical imaging lens assembly, and TTL and EPD satisfy TTL/EPD<2.

### CROSS-REFERENCE TO RELATED APPLICATION

The disclosure claims priority to and the benefit of Chinese Patent Application No. 201910927088.4, filed to the China National Intellectual Property Administration (CHIPA) on 27 Sep. 2019, which is hereby incorporated by reference in its entirety.

### TECHNICAL FIELD

The disclosure relates to the technical field of imaging by optical lens imaging, and particularly to an optical imaging lens assembly.

### BACKGROUND

In the field of photography, a telephoto lens has irreplaceable advantages in telephotographing and detail capturing. In recent years, telephoto lenses have been used for more and more mobile phones to achieve relatively high spatial angular resolutions so as to enhance high-frequency information in combination with image fusion technologies. As a portable electronic device, a mobile phone has relatively high requirements on a size and imaging of a telephoto lens. A camera of a mobile phone is unlikely to combine great focal length, ultra-thin performance and high resolution.

That is, there is a problem that an optical imaging lens assembly in the related art may not have all of long focal length, ultra-thin performance and high resolution at the same time.

### SUMMARY

Some embodiments of the disclosure provide an optical imaging lens assembly, so as to solve the problem in the related art that an optical imaging lens assembly may not have all of long focal length, ultra-thin performance and high resolution at the same time.

An embodiment of the disclosure provides an optical imaging lens assembly, which sequentially includes from an object side to an image side along an optical axis: a first lens with a refractive power; a second lens with a refractive power, an image-side surface of the second lens is a concave surface; a third lens with a positive refractive power, an object-side surface of the third lens is a convex surface; a fourth lens with a refractive power; and a fifth lens with a refractive power TTL is a distance from an object-side surface of the first lens to an imaging surface of the optical imaging lens assembly on the optical axis, EPD is an Entrance Pupil Diameter of the optical imaging lens assembly, and TTL and EPD satisfy TTL/EPD<2.

In an implementation mode, an effective focal length f1 of the first lens and an effective focal length f of the optical imaging lens assembly satisfy 1<f1/f<1.5.

In an implementation mode, BFL is a distance from an image-side surface of the fifth lens to the imaging surface of the optical imaging lens assembly on the optical axis, TTL is the distance from the object-side surface of the first lens to the imaging surface of the optical imaging lens assembly on the optical axis, and BFL and TTL satisfy BFL/TTL<0.12.

In an implementation mode, curvature radius R4 of the image-side surface of the second lens and a curvature radius R5 of the object-side surface of the third lens satisfy 3<(R4+R5)/(R4−R5)<6.

In an implementation mode, curvature radius R7 of an object-side surface of the fourth lens and a curvature radius R8 of an image-side surface of the fourth lens satisfy 0.7<R7/R8<1.2.

In an implementation mode, T34 is a distance between the third lens and the fourth lens on the optical axis, TD is a distance from an object-side surface of the first lens to an image-side surface of the fifth lens on the optical axis, and T34 and TD satisfy 0.2<T34/TD<0.3.

In an implementation mode, T12 is a distance between the first lens and the second lens on the optical axis, T23 is a distance between the second lens and the third lens on the optical axis, and T12 and T23 satisfy 1.5<T12/T23<3.6.

In an implementation mode, SAG41 is an on-axis distance from an intersection point of an object-side surface of the fourth lens and the optical axis to an effective radius vertex of the object-side surface of the fourth lens, and SAG41 and a center thickness CT4 of the fourth lens on the optical axis satisfy −0.25<SAG41/CT4<0.

In an implementation mode, an edge thickness ET4 of the fourth lens and an edge thickness ET5 of the fifth lens satisfy 1<ET4/ET5<1.5.

In an implementation mode, SAG51 is an on-axis distance from an intersection point of an object-side surface of the fifth lens and the optical axis to an effective radius vertex of the object-side surface of the fifth lens, T45 is a distance between the fourth lens and the fifth lens on the optical axis, and SAG51 and T45 satisfy −1.3<SAG51/T45<−0.8.

In an implementation mode, SAG31 is an on-axis distance from an intersection point of the object-side surface of the third lens and the optical axis to an effective radius vertex of the object-side surface of the third lens, and SAG31 and a center thickness CT3 of the third lens on the optical axis satisfy 0.3<SAG31/CT3<0.7.

In an implementation mode, DT52 is an effective radius of an image-side surface of the fifth lens, ImgH is a half of a diagonal length of an effective pixel region on the imaging surface, and DT52 and ImgH satisfy 0.8<DT52/ImgH<1.

In an implementation mode, DT12 is an effective radius of an image-side surface of the first lens, DT41 is an effective radius of an object-side surface of the fourth lens, and DT12 and DT41 satisfy 1<DT12/DT41<1.5.

In an implementation mode, an effective focal length f3 of the third lens and an effective focal length f of the optical imaging lens assembly satisfy 0.5<f3/f<1.

Another embodiment of the disclosure provides an optical imaging lens assembly, which sequentially includes from an object side to an image side along an optical axis: a first lens with a refractive power; a second lens with a refractive power, an image-side surface of the second lens is a concave surface; a third lens with a positive refractive power, an object-side surface of the third lens is a convex surface; a fourth lens with a refractive power; and a fifth lens with a refractive power. f123 is a combined focal length of the first lens, the second lens and the third lens, f45 is a combined focal length of the fourth lens and the fifth lens, and f123 and f45 satisfy −1.2<f123/f45<−0.7.

In an implementation mode, TTL is a distance from an object-side surface of the first lens to an imaging surface on the optical axis, EPD is an Entrance Pupil Diameter of the optical imaging lens assembly, and TTL and EPD satisfy TTL/EPD<2.

In an implementation mode, an effective focal length f1 of the first lens and an effective focal length f of the optical imaging lens assembly satisfy 1<f1/f<1.5.

In an implementation mode, BFL is a distance from an image-side surface of the fifth lens to the imaging surface of the optical imaging lens assembly on the optical axis, TTL is a distance from an object-side surface of the first lens to an imaging surface of the optical imaging lens assembly on the optical axis, and BFL and TTL satisfy BFL/TTL<0.12.

In an implementation mode, a curvature radius R4 of the image-side surface of the second lens and a curvature radius R5 of the object-side surface of the third lens satisfy 3<(R4+R5)/(R4−R5)<6.

In an implementation mode, a curvature radius R7 of an object-side surface of the fourth lens and a curvature radius R8 of an image-side surface of the fourth lens satisfy 0.7<R7/R8<1.2.

In an implementation mode, T34 is a distance between the third lens and the fourth lens on the optical axis, TD is a distance from an object-side surface of the first lens to an image-side surface of the fifth lens on the optical axis, and T34 and TD satisfy 0.2<T34/TD<0.3.

In an implementation mode, T12 is a distance between the first lens and the second lens on the optical axis, T23 is a distance between the second lens and the third lens on the optical axis, and T12 and T23 satisfy 1.5<T12/T23<3.6.

In an implementation mode, SAG41 is an on-axis distance from an intersection point of an object-side surface of the fourth lens and the optical axis to an effective radius vertex of the object-side surface of the fourth lens, and SAG41 and a center thickness CT4 of the fourth lens on the optical axis satisfy −0.25<SAG41/CT4<0.

In an implementation mode, an edge thickness ET4 of the fourth lens and an edge thickness ET5 of the fifth lens satisfy 1<ET4/ET5<1.5.

In an implementation mode, SAG51 is an on-axis distance from an intersection point of an object-side surface of the fifth lens and the optical axis to an effective radius vertex of the object-side surface of the fifth lens, T45 is a distance between the fourth lens and the fifth lens on the optical axis, and SAG51 and T45 satisfy −1.3<SAG51/T45<−0.8.

In an implementation mode, SAG31 is an on-axis distance from an intersection point of the object-side surface of the third lens and the optical axis to an effective radius vertex of the object-side surface of the third lens, and SAG31 and a center thickness CT3 of the third lens on the optical axis satisfy 0.3<SAG31/CT3<0.7.

In an implementation mode, DT52 is an effective radius of an image-side surface of the fifth lens, ImgH is a half of a diagonal length of an effective pixel region on the imaging surface, and DT52 and ImgH satisfy 0.8<DT52/ImgH<1.

In an implementation mode, DT12 is an effective radius of an image-side surface of the first lens, DT41 is an effective radius of an object-side surface of the fourth lens, and DT12 and DT41 satisfy 1<DT12/DT41<1.5.

In an implementation mode, an effective focal length f3 of the third lens and an effective focal length f of the optical imaging lens assembly satisfy 0.5<f3/f<1.

With the adoption of the technical solution of the disclosure, an optical imaging lens assembly sequentially includes from an object side to an image side along an optical axis: a first lens with a refractive power; a second lens with a refractive power, an image-side surface of the second lens is a concave surface, a third lens with a positive refractive power, an object-side surface of the third lens is a convex surface; a fourth lens with a refractive power; and a fifth lens with a refractive power. TTL is a distance from an object-side surface of the first lens to an imaging surface of the optical imaging lens assembly on the optical axis. EPD is an Entrance Pupil Diameter of the optical imaging lens assembly, and TTL and EPD satisfy TTL/EPD<2.

Surface types and refractive powers are configured reasonably, so that astigmatisms and distortions may be reduced effectively, an imaging quality of the optical imaging lens assembly may be improved greatly, and a larger aperture may be achieved on the premise of reducing the overall size of the lens and ensuring the normal yield to increase a luminous flux to further achieve an effect of highlighting a subject. Setting TTL/EPD<2 achieves a certain balance between an enlargement of an optical space of the optical imaging lens assembly and a reduction of a total length of the optical imaging lens assembly, so as to avoid an excessive increment of the optical space caused by the reduction of the total length of the optical imaging lens assembly.

### BRIEF DESCRIPTION OF THE DRAWINGS

The drawings, which constitute a part of the disclosure, in the specification are used to provide a further understanding to the disclosure. Schematic embodiments of the disclosure and descriptions thereof are used to explain the disclosure and not intended to form improper limits to the disclosure. In the drawings:

FIG. 1 shows a structural schematic diagram of an optical imaging lens assembly according to Example 1 of the disclosure;

FIG. 2 shows a longitudinal aberration curve of the optical imaging lens assembly in FIG. 1;

FIG. 3 shows an astigmatism curve of the optical imaging lens assembly in FIG. 1;

FIG. 4 shows a distortion curve of the optical imaging lens assembly in FIG. 1;

FIG. 5 shows a lateral color curve of the optical imaging lens assembly in FIG. 1;

FIG. 6 shows a structural schematic diagram of an optical imaging lens assembly according to Example 2 of the disclosure;

FIG. 7 shows a longitudinal aberration curve of the optical imaging lens assembly in FIG. 6;

FIG. 8 shows an astigmatism curve of the optical imaging lens assembly in FIG. 6;

FIG. 9 shows a distortion curve of the optical imaging lens assembly in FIG. 6;

FIG. 10 shows a lateral color curve of the optical imaging lens assembly in FIG. 6;

FIG. 11 shows a structural schematic diagram of an optical imaging lens assembly according to Example 3 of the disclosure;

FIG. 12 shows a longitudinal aberration curve of the optical imaging lens assembly in FIG. 11;

FIG. 13 shows an astigmatism curve of the optical imaging lens assembly in FIG. 11;

FIG. 14 shows a distortion curve of the optical imaging lens assembly in FIG. 11;

FIG. 15 shows a lateral color curve of the optical imaging lens assembly in FIG. 11;

FIG. 16 shows a structural schematic diagram of an optical imaging lens assembly according to Example 4 of the disclosure;

FIG. 17 shows a longitudinal aberration curve of the optical imaging lens assembly in FIG. 16;

FIG. 18 shows an astigmatism curve of the optical imaging lens assembly in FIG. 16;

FIG. 19 shows a distortion curve of the optical imaging lens assembly in FIG. 16;

FIG. 20 shows a lateral color curve of the optical imaging lens assembly in FIG. 16;

FIG. 21 shows a structural schematic diagram of an optical imaging lens assembly according to Example 5 of the disclosure;

FIG. 22 shows a longitudinal aberration curve of the optical imaging lens assembly in FIG. 21;

FIG. 23 shows an astigmatism curve of the optical imaging lens assembly in FIG. 21;

FIG. 24 shows a distortion curve of the optical imaging lens assembly in FIG. 21;

FIG. 25 shows a lateral color curve of the optical imaging lens assembly in FIG. 21;

FIG. 26 shows a structural schematic diagram of an optical imaging lens assembly according to Example 6 of the disclosure;

FIG. 27 shows a longitudinal aberration curve of the optical imaging lens assembly in FIG. 26;

FIG. 28 shows an astigmatism curve of the optical imaging lens assembly in FIG. 26;

FIG. 29 shows a distortion curve of the optical imaging lens assembly in FIG. 26;

FIG. 30 shows a lateral color curve of the optical imaging lens assembly in FIG. 26;

FIG. 31 shows a structural schematic diagram of an optical imaging lens assembly according to Example 7 of the disclosure;

FIG. 32 shows a longitudinal aberration curve of the optical imaging lens assembly in FIG. 31;

FIG. 33 shows an astigmatism curve of the optical imaging lens assembly in FIG. 31;

FIG. 34 shows a distortion curve of the optical imaging lens assembly in FIG. 31;

FIG. 35 shows a lateral color curve of the optical imaging lens assembly in FIG. 31;

FIG. 36 shows a structural schematic diagram of an optical imaging lens assembly according to Example 8 of the disclosure;

FIG. 37 shows a longitudinal aberration curve of the optical imaging lens assembly in FIG. 36;

FIG. 38 shows an astigmatism curve of the optical imaging lens assembly in FIG. 36;

FIG. 39 shows a distortion curve of the optical imaging lens assembly in FIG. 36;

FIG. 40 shows a lateral color curve of the optical imaging lens assembly in FIG. 36;

FIG. 41 shows a structural schematic diagram of an optical imaging lens assembly according to Example 9 of the disclosure;

FIG. 42 shows a longitudinal aberration curve of the optical imaging lens assembly in FIG. 41;

FIG. 43 shows an astigmatism curve of the optical imaging lens assembly in FIG. 41;

FIG. 44 shows a distortion curve of the optical imaging lens assembly in FIG. 41;

FIG. 45 shows a lateral color curve of the optical imaging lens assembly in FIG. 41;

FIG. 46 shows a structural schematic diagram of an optical imaging lens assembly according to Example 10 of the disclosure;

FIG. 47 shows a longitudinal aberration curve of the optical imaging lens assembly in FIG. 46;

FIG. 48 shows an astigmatism curve of the optical imaging lens assembly in FIG. 46;

FIG. 49 shows a distortion curve of the optical imaging lens assembly in FIG. 46;

FIG. 50 shows a lateral color curve of the optical imaging lens assembly in FIG. 46;

FIG. 51 shows a structural schematic diagram of an optical imaging lens assembly according to Example 11 of the disclosure;

FIG. 52 shows a longitudinal aberration curve of the optical imaging lens assembly in FIG. 51;

FIG. 53 shows an astigmatism curve of the optical imaging lens assembly in FIG. 51;

FIG. 54 shows a distortion curve of the optical imaging lens assembly in FIG. 51; and

FIG. 55 shows a lateral color curve of the optical imaging lens assembly in FIG. 51.

The drawings include the following reference signs:
L1—a first lens; S1—an object-side surface of the first lens; S2—an image-side surface of the first lens; L2—a second lens; S3—an object-side surface of the second lens; S4—an image-side surface of the second lens, L3—a third lens; S5—an object-side surface of the third lens; S6—an image-side surface of the third lens; L4—a fourth lens; S7—an object-side surface of the fourth lens; S8—an image-side surface of the fourth lens; L5—a fifth lens; S9—an object-side surface of the fifth lens; S10—an image-side surface of the fifth lens; L6—an optical filter; S11—an object-side surface of the optical filter; S12—an image-side surface of the optical filter; S13—an imaging surface; and STO—a diaphragm.

### DETAILED DESCRIPTION OF THE EMBOCIMENTS

It is to be noted that the embodiments in the disclosure and features in the embodiments may be combined without conflicts. The disclosure will be described below with reference to the drawings and in combination with the embodiments in detail.

It is to be pointed out that, unless otherwise specified, all technical and scientific terms used in the disclosure have the same meanings as commonly understood by those of ordinary skill in the art of the disclosure.

In the disclosure, unless conversely specified, the used orientation terms “upper, lower, top, and bottom” are usually for the directions shown in the drawings, or for a component in a vertical, perpendicular, or gravity direction. Similarly, for convenient understanding and description, “inner and outer” refer to inner and outer relative to a contour of each component. However, these orientation terms are not intended to limit the disclosure.

It should be noted that, in this description, expressions first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region, and if a lens surface is a concave surface and a position of the concave surface is not defined, it indicates that the lens surface is a concave surface at least in the paraxial region. A surface, close to an object side, of each lens is called an object-side surface of the lens, and a surface, close to an image side, of each lens is called an image-side surface of the lens. A surface type of the paraxial region may be judged according to a judgment manner known to those of ordinary skill in the art, and whether a surface is concave or convex is judged according to whether an R value is positive or negative (R refers to a curvature radius of the paraxial region, usually refers to an R value on lens data in optical software). For example, an object-side surface is determined as a convex surface if the R value is positive, and is determined as a concave surface if the R value is negative. An image-side surface is determined as a concave surface if the R value is positive, and is determined as a convex surface is the R value is negative.

The disclosure is mainly intended to provide an optical imaging lens assembly, so as to solve the problem in the related art that an optical imaging lens assembly may not have all of long focal length, ultra-thin performance and high resolution at the same time.

### Embodiment 1

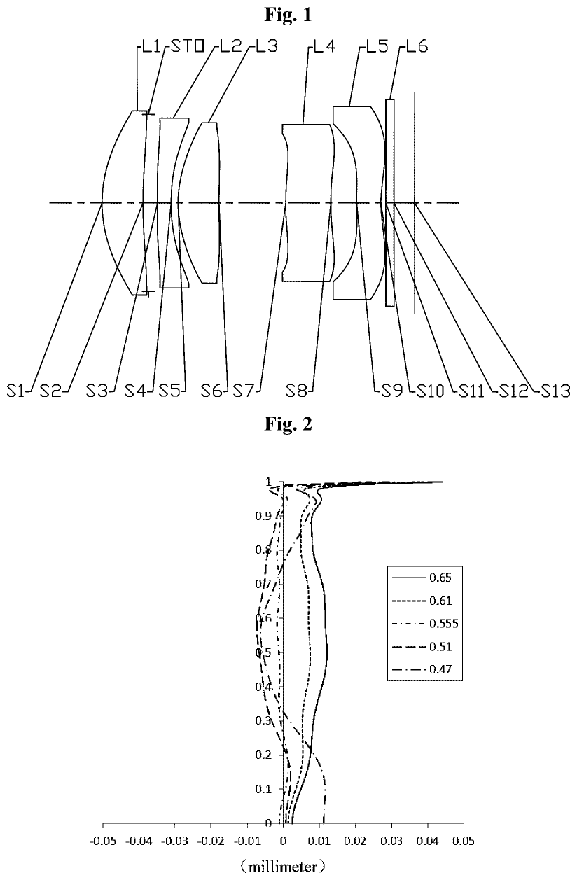

As shown in FIGS. 1 to 55, an optical imaging lens assembly sequentially includes from an object side to an image side along an optical axis: a first lens with a refractive power; a second lens with a refractive power, an image-side surface of the second lens is a concave surface; a third lens with a positive refractive power, an object-side surface of the third lens is a convex surface; a fourth lens with a refractive power; and a fifth lens with a refractive power. TTL is a distance from an object-side surface of the first lens to an imaging surface of the optical imaging lens assembly on the optical axis, EPD is an Entrance Pupil Diameter of the optical imaging lens assembly, and TTL and EPD satisfy TTL/EPD<2.

Surface types and refractive powers are configured reasonably, so that astigmatisms and distortions may be reduced effectively, an imaging quality of the optical imaging lens assembly may be improved greatly, and a larger aperture may be achieved on the premise of reducing the overall size of the lens and ensuring the normal yield to increase a luminous flux to further achieve an effect of highlighting a subject. Setting TTL/EPD<2 achieves a certain balance between an enlargement of an optical space of the optical imaging lens assembly and a reduction of a total length of the optical imaging lens assembly, so as to avoid an excessive increment of the optical space caused by the reduction of the total length of the optical imaging lens assembly.

In the embodiment, an effective focal length f1 of the first lens and an effective focal length f of the optical imaging lens assembly satisfy 1<f1/f<1.5. The effective focal length f1 of the first lens is controlled reasonably, so that a focusing function may be realized well.

The effective focal length of the first lens and the effective focal length of the optical imaging lens assembly are controlled in a reasonable range, so that a spherical aberration may be reduced to achieve a higher imaging resolution of the optical imaging lens assembly.

In the embodiment, f123 is a combined focal length of the first lens, the second lens and the third lens, f45 is a combined focal length of the fourth lens and the fifth lens, and f123 and f45 satisfy −1.2<f123/f45<−0.7. The first lens, the second lens and the third lens are considered as a front lens group, and the fourth lens and the fifth lens are considered as a rear lens group. Focal lengths of the front lens group and the rear lens group are configured to help to achieve a feature of long focal length of the optical imaging lens assembly.

In the embodiment, a curvature radius R4 of the image-side surface of the second lens and a curvature radius R5 of the object-side surface of the third lens satisfy 3<(R4+R5)/(R4−R5)<6. Such a setting endows the front lens group with a good focusing function, may reduce a spherical aberration and longitudinal aberration of the optical imaging lens assembly effectively, and improve an imaging resolution of the optical imaging lens assembly greatly.

In the embodiment, a curvature radius R7 of an object-side surface of the fourth lens and a curvature radius R8 of an image-side surface of the fourth lens satisfy 0.7<R7/R8<1.2. Such a setting may achieve a feature of negative refractive power of the rear lens group well, and meanwhile, may reduce a spherochromatic aberration of the optical imaging lens assembly effectively.

In the embodiment, T34 is a distance between the third lens and the fourth lens on the optical axis. TD is a distance from an object-side surface of the first lens to an image-side surface of the fifth lens on the optical axis, and T34 and TD satisfy 0.2<T34/TD<0.3. The front lens group is spaced from the rear lens group, so that the refractive power may be transitioned well to achieve a feature of long focal length of the optical imaging lens assembly.

In the embodiment, T12 is a distance between the first lens and the second lens on the optical axis, T23 is a distance between the second lens and the third lens on the optical axis, and T12 and T23 satisfy 1.5<T12/T23<3.6. The first lens, the second lens and the third lens are spaced reasonably, so that a longitudinal aberration and an off-axis aberration of the optical imaging lens assembly may be reduced effectively to improve an imaging quality of the optical imaging lens assembly.

In the embodiment, SAG41 is an on-axis distance from an intersection point of an object-side surface of the fourth lens and the optical axis to an effective radius vertex of the object-side surface of the fourth lens, and SAG41 and a center thickness CT4 of the fourth lens on the optical axis satisfy −0.25<SAG41/CT4<0. Such a setting may achieve a feature of negative refractive power of the rear lens group well, and meanwhile, may reduce a field curvature and distortion of the optical imaging lens assembly effectively.

In the embodiment, an edge thickness ET4 of the fourth lens and an edge thickness ET5 of the fifth lens satisfy 1<ET4/ET5<1.5 Such a setting may ensure relative luminance of a marginal field of view, and meanwhile, reduces an off-axis aberration of the optical imaging lens assembly effectively.

In the embodiment, SAG51 is an on-axis distance from an intersection point of an object-side surface of the fifth lens and the optical axis to an effective radius vertex of the object-side surface of the fifth lens, T45 is a distance between the fourth lens and the fifth lens on the optical axis, and SAG51 and T45 satisfy −1.3<SAG51/T45<−0.8. Such a setting may reduce a field curvature and astigmatism of the optical imaging lens assembly well, and meanwhile, ensures an incident angle of the chief ray.

In the embodiment, SAG31 is an on-axis distance from an intersection point of the object-side surface of the third lens and the optical axis to an effective radius vertex of the object-side surface of the third lens, and SAG31 and a center thickness CT3 of the third lens on the optical axis satisfy 0.3<SAG31/CT3<0.7. Such a setting may ensure a feature of positive refractive power of the front lens group, and meanwhile, reduces a spherical aberration and spherochromatic aberration of the optical imaging lens assembly effectively.

In the embodiment, DT52 is an effective radius of an image-side surface of the fifth lens, ImgH is a half of a diagonal length of an effective pixel region on the imaging surface, and DT52 and ImgH satisfy 0.8<DT52/ImgH<1. Such a setting implements the matching of an incident angle of the chief ray well to help the chief ray to pass through, and may also reduce a field curvature of the optical imaging lens assembly effectively.

In the embodiment, DT12 is an effective radius of an image-side surface of the first lens, DT41 is an effective radius of an object-side surface of the fourth lens, and DT12 and DT41 satisfy 1<DT12/DT41<1.5. Such a setting may match the front lens group and the rear lens group well and implement the matching of a chief ray angle effectively.

In the embodiment, an effective focal length f3 of the third lens and an effective focal length f of the optical imaging lens assembly satisfy 0.5<f3/f<1. Such a setting may achieve a focusing feature of the front lens group well. The refractive powers of the first lens group are matched to eliminate a longitudinal aberration of the optical imaging lens assembly effectively.

In the embodiment, BFL is a distance from an image-side surface of the fifth lens to the imaging surface on the optical axis, TTL is the distance from the object-side surface of the first lens to the imaging surface of the optical imaging lens assembly on the optical axis, and BFL and TTL satisfy BFL/TTL<0.12. Such a setting may achieve a feature of long focal length of the optical imaging lens assembly well, and meanwhile, ensures an incident angle of the chief ray effectively.

### Embodiment 2

An optical imaging lens assembly sequentially includes from an object side to an image side along an optical axis: a first lens with a refractive power; a second lens with a refractive power, an image-side surface of the second lens is a concave surface; a third lens with a positive refractive power, an object-side surface of the third lens being a convex surface; a fourth lens with a refractive power and a fifth lens with a refractive power. f123 is a combined focal length of the first lens, the second lens and the third lens, f45 is a combined focal length of the fourth lens and the fifth lens, and f123 and f45 satisfy −1.2<f123/f45<−0.7.

Surface types and refractive powers are configured reasonably, so that astigmatisms and distortions may be reduced effectively, an imaging quality of the optical imaging lens assembly may be improved greatly, and a larger aperture may be achieved on the premise of reducing the overall size of the lens and ensuring the normal yield to increase a luminous flux to further achieve an effect of highlighting a subject. The first lens, the second lens and the third lens are considered as a front lens group, and the fourth lens and the fifth lens are considered as a rear lens group. Focal lengths of the front lens group and the rear lens group are configured to help to achieve a feature of long focal length of the optical imaging lens assembly.

In the embodiment, TTL is a distance from an object-side surface to an imaging surface on the optical axis, EPD is an Entrance Pupil Diameter of the optical imaging lens assembly, and TTL and EPD satisfy TTL/EPD<2. Such a setting achieves a certain balance between an enlargement of an optical space of the optical imaging lens assembly and a reduction of a total length of the optical imaging lens assembly, so as to avoid an excessive increment of the optical space caused by the reduction of the total length of the optical imaging lens assembly.

In the embodiment, an effective focal length f1 of the first lens and an effective focal length f of the optical imaging lens assembly satisfy 1<f1/f<1.5 The effective focal length f1 of the first lens is controlled reasonably, so that a focusing function may be realized well. The effective focal length of the first lens and the effective focal length of the optical imaging lens assembly are controlled in a reasonable range, so that a spherical aberration may be reduced to achieve a higher imaging resolution of the optical imaging lens assembly.

In the embodiment, BFL is a distance from an image-side surface of the fifth lens to the imaging surface on the optical axis, TTL is a distance from an object-side surface of the first lens to an imaging surface of the optical imaging lens assembly on the optical axis, and BFL and TTL satisfy BFL/TTL<0.12. Such a setting may achieve a feature of long focal length of the optical imaging lens assembly well, and meanwhile, ensures an incident angle of the chief ray effectively.

In the embodiment, a curvature radius R4 of the image-side surface of the second lens and a curvature radius R5 of the object-side surface of the third lens satisfy 3<(R4+R5)/(R4−R5)<6. Such a setting endows the front lens group with a good focusing function, may reduce a spherical aberration and longitudinal aberration of the optical imaging lens assembly effectively, and improve an imaging resolution of the optical imaging lens assembly greatly.

In the embodiment, a curvature radius R7 of an object-side surface of the fourth lens and a curvature radius R8 of an image-side surface of the fourth lens satisfy 0.7<R7/R8<1.2. Such a setting may achieve a feature of negative refractive power of the rear lens group well, and meanwhile, may reduce a spherochromatic aberration of the optical imaging lens assembly effectively.

In the embodiment, T34 is a distance between the third lens and the fourth lens on the optical axis, TD is a distance from an object-side surface of the first lens to an image-side surface of the fifth lens on the optical axis, and T34 and TD satisfy 0.2<T34/TD<0.3. The front lens group is spaced from the rear lens group, so that the refractive power may be transitioned well to achieve a feature of long focal length of the optical imaging lens assembly.

In the embodiment, T12 is a distance between the first lens and the second lens on the optical axis, T23 is a distance between the second lens and the third lens on the optical axis, and T12 and T23 satisfy 1.5<T12/T23<3.6. The first lens, the second lens and the third lens are spaced reasonably, so that a longitudinal aberration and an off-axis aberration of the optical imaging lens assembly may be reduced effectively to improve an imaging quality of the optical imaging lens assembly.

In the embodiment, SAG41 is an on-axis distance from an intersection point of an object-side surface of the fourth lens and the optical axis to an effective radius vertex of the object-side surface of the fourth lens, and SAG41 and a center thickness CT4 of the fourth lens on the optical axis satisfy −0.25<SAG41/CT4<0. Such a setting may achieve a feature of negative refractive power of the rear lens group well, and meanwhile, may reduce a field curvature and distortion of the optical imaging lens assembly effectively.

In the embodiment, an edge thickness ET4 of the fourth lens and an edge thickness ET5 of the fifth lens satisfy 1<ET4/ET5<1.5. Such a setting may ensure relative luminance of a marginal field of view, and meanwhile, reduces an off-axis aberration of the optical imaging lens assembly effectively.

In the embodiment, SAG51 is an on-axis distance from an intersection point of an object-side surface of the fifth lens and the optical axis to an effective radius vertex of the object-side surface of the fifth lens, T45 is a distance between the fourth lens and the fifth lens on the optical axis, and SAG51 and T45 satisfy-1.3<SAG51/T45<−0.8 Such a setting may reduce a field curvature and astigmatism of the optical imaging lens assembly well, and meanwhile, ensures an incident angle of the chief ray.

In the embodiment. SAG31 is an on-axis distance from an intersection point of the object-side surface of the third lens and the optical axis to an effective radius vertex of the object-side surface of the third lens, and SAG31 and a center thickness CT3 of the third lens on the optical axis satisfy 0.3<SAG31/CT3<0.7. Such a setting may ensure a feature of positive refractive power of the front lens group, and meanwhile, reduces a spherical aberration and spherochromatic aberration of the optical imaging lens assembly effectively.

In the embodiment, DT52 is an effective radius of an image-side surface of the fifth lens, ImgH is a half of a diagonal length of an effective pixel region on the imaging surface, and DT52 and ImgH satisfy 0.8<DT52/ImgH<1. Such a setting implements the matching of an incident angle of the chief ray well to help the chief ray to pass through, and may also reduce a field curvature of the optical imaging lens assembly effectively.

In the embodiment. DT12 is an effective radius of an image-side surface of the first lens, DT41 is an effective radius of an object-side surface of the fourth lens, and DT12 and DT41 satisfy 1<DT12/DT41<1.5. Such a setting may match the front lens group and the rear lens group well and implement the matching of an incident angle of the chief ray effectively.

In the embodiment, an effective focal length f3 of the third lens and an effective focal length f of the optical imaging lens assembly satisfy 0.5<f3/f<1. Such a setting may achieve a focusing feature of the front lens group well. The refractive powers of the first lens group are matched to eliminate a longitudinal aberration of the optical imaging lens assembly effectively. The optical imaging lens assembly may further include at least one diaphragm, to improve an imaging quality of the lens. In an embodiment, the diaphragm may be arranged between the first lens and the second lens. In another embodiment, the optical imaging lens assembly may further include an optical filter configured to correct the chromatic aberration and/or protective a glass configured to protect a photosensitive element on the imaging surface.

The optical imaging lens assembly of the disclosure may adopt multiple lenses, for example, the above-mentioned five. The refractive powers and surface types of each lens, the center thicknesses of each lens, on-axis distances between the lenses and the like may be reasonably configured to effectively enlarge an aperture of the optical imaging lens assembly, reduce a sensitivity of the lens, improve a machinability of the lens, and ensure that the optical imaging lens assembly is more favorable for production and machining and applicable to a portable electronic device. The optical imaging lens assembly also has the advantages of large aperture, ultra-thin design and high imaging quality, and may satisfy a miniaturization requirement of an intelligent electronic product. In addition, a large-aperture design may achieve a higher luminous flux so as to reduce an optical aberration in low light and improve an image acquisition quality to achieve a stable imaging effect.

In the disclosure, at least one of mirror surfaces of the lenses is an aspheric mirror surface. An aspheric lens has a feature that a curvature keeps changing from a center of the lens to a periphery of the lens. Unlike a spherical lens with a constant curvature from a center of the lens to a periphery of the lens, the aspheric lens has a better curvature radius feature and the advantages of improving distortions and improving astigmatism aberrations. With the adoption of the aspheric lens, astigmatism aberrations during imaging may be eliminated as much as possible, thereby improving the imaging quality.

However, those skilled in the art should know that the number of the lenses forming the optical imaging lens assembly may be changed without departing from the technical solutions claimed in the disclosure to achieve each result and advantage described in the specification. For example, although descriptions are made in the embodiments with five lenses as an example, the optical imaging lens assembly is not limited to five lenses. If necessary, the optical imaging lens assembly may further include another number of lenses.

Examples of specific surface types and parameters applied to the optical imaging lens assembly of the above-mentioned embodiment will further be described below with reference to the drawings.

It is to be noted that any one of the following Example 1 to Example 11 is applicable to all embodiments of the disclosure.

### Example 1

As shown in FIG. 1, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a concave surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a convex surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 1 shows a surface type, curvature radius, thickness, material and conic coefficient of each lens of the optical imaging lens assembly according to Example 1, wherein the units of the curvature radius and the thickness are all millimeters.

TABLE 1
Detailed Optical Data of Each Lens in Example 1

| | | | | Material | |
|---|---|---|---|---|---|
| | | | | (refrac- | |
| | | | | tive | |
| | | | | index/ | Conic |
| Surface | Surface | Curvature | Thick- | Abbe | coef- |
| number | type | radius | ness | number) | ficient |
| OBJ | Spherical | Infinite | Infinite | | |
| S1 | Aspheric | 3.4339 | 1.0500 | 1.55/56.1 | −0.3847 |
| S2 | Aspheric | 17.0977 | 0.1361 | | −13.8633 |
| STO | Spherical | Infinite | 0.2327 | | |
| S3 | Aspheric | −34.0953 | 0.3500 | 1.64/23.5 | 36.7081 |
| S4 | Aspheric | 5.2233 | 0.1775 | | −10.4212 |
| S5 | Aspheric | 2.7742 | 1.0500 | 1.55/56.1 | −5.0946 |
| S6 | Aspheric | 19.3780 | 1.7099 | | 47.8583 |
| S7 | Aspheric | 6.9135 | 1.1536 | 1.64/23.5 | −12.7720 |
| S8 | Aspheric | 6.3491 | 0.6613 | | −9.1730 |
| S9 | Aspheric | 14.4613 | 0.6211 | 1.55/56.1 | 22.7394 |
| S10 | Aspheric | 3.1638 | 0.1261 | | −6.8675 |
| S11 | Spherical | Infinite | 0.2100 | 1.52/64.2 | |
| S12 | Spherical | Infinite | 0.5276 | | |
| S13 | Spherical | Infinite | | | |

In the example, each lens may use an aspheric lens, and a surface type x of each aspheric surface is defined through the following formula:

$$x = \frac{{ch}^{2}}{1 + \sqrt{1 - ( k + 1 ) {c}^{2} {h}^{2}}} + \sum ai \text{?} \qquad Formula ( 1 )$$

$$\text{?} \text{indicates text missing or illegible when filed}$$

wherein x is a vector height of a distance between the aspheric surface and a vertex of the aspheric surface when the aspheric surface is located at a position with the height h in an optical axis direction, c is a paraxial curvature of the aspheric surface, c=1/R (namely, the paraxial curvature c is a reciprocal of the curvature radius R in Table 1 above), k is a conic coefficient (specified in Table 1); and Ai is a correction coefficient of the i-th order of the aspheric surface.

Table 2 shows high-order coefficients that may be used for each aspheric surface of each aspheric lens in the example.

TABLE 2
High-Order Coefficients of Each Aspheric Surface in Example 1

| Surface | | | | | | | | | |
|---|---|---|---|---|---|---|---|---|---|
| number | A4 | A6 | A8 | A10 | A12 | A14 | A16 | A18 | A20 |
| S1 | −9.5222E−04 | 4.9098E−05 | −7.7708E−04 | 5.7274E−04 | −2.5249E−04 | 6.9061E−05 | −1.1588E−05 | 1.0994E−08 | −4.4371E−08 |
| S2 | 1.1333E−02 | −9.2359E−03 | 2.6894E−03 | 7.2913E−05 | −3.6441E−04 | 1.4325E−04 | −2.7587E−06 | 2.7644E−06 | −1.1484E−07 |
| S3 | 5.7754E−02 | −5.3426E−02 | 3.6702E−02 | −1.8379E−02 | 6.4136E−03 | −1.5220E−03 | 2.3519E−04 | −2.1386E−05 | 8.8549E−07 |
| S4 | 4.3832E−02 | −6.2028E−02 | 4.7215E−02 | −2.8098E−02 | 1.1141E−02 | −2.9733E−03 | 6.1742E−04 | −5.3226E−05 | 2.4480E−06 |
| S5 | 3.2433E−03 | −1.0588E−02 | 1.4717E−02 | −1.0042E−02 | 4.3232E−03 | −1.2380E−03 | 2.2986E−04 | −2.4887E−06 | 1.1827E−06 |
| S6 | −1.4628E−02 | 9.7745E−05 | 9.4031E−04 | −6.0740E−04 | 4.7390E−04 | −1.8781E−04 | 4.6546E−05 | −6.2996E−06 | 3.5151E−07 |
| S7 | −1.3658E−02 | −3.6904E−03 | 1.6121E−04 | −3.4423E−04 | 3.7923E−05 | −8.8769E−06 | 0.0000E+00 | 0.0000E+00 | 0.0000E+00 |
| S8 | −1.2764E−02 | 4.3284E−03 | −6.4880E−03 | 4.5402E−03 | −2.4079E−03 | 8.8904E−04 | −2.1364E−04 | 3.0115E−65 | −1.8858E−08 |
| S9 | −8.8448E−02 | 3.2381E−02 | −1.5252E−02 | 6.5705E−03 | −2.3961E−02 | 6.6498E−04 | −1.4477E−04 | 2.2854E−05 | −1.7162E−06 |
| S10 | −6.9048E−02 | 3.5115E−02 | −1.9089E−02 | 7.8319E−03 | −2.3281E−03 | 4.5358E−04 | −5.4924E−05 | 3.7332E−08 | −1.0947E−07 |

Table 3 shows an effective focal length f of the optical imaging lens assembly in Example 1, effective focal lengths f1 to f5 of each lens, a distance TTL from the object-side surface S1 of the first lens to the imaging surface S13 and ImgH, wherein ImgH is a half of a diagonal length of an effective pixel region on the imaging surface of the optical imaging lens assembly.

TABLE 3
Parameters of the Optical Imaging Lens Assembly

| | |
|---|---|
| TTL (mm) | 8.01 |
| ImgH (mm) | 2.83 |
| f (mm) | 6.61 |
| f1 (mm) | 7.66 |
| f2 (mm) | −7.00 |
| f3 (mm) | 5.80 |
| f4 (mm) | −606.87 |
| f5 (mm) | −7.56 |

Specific values of each conditional expression in the example refer to Table 34.

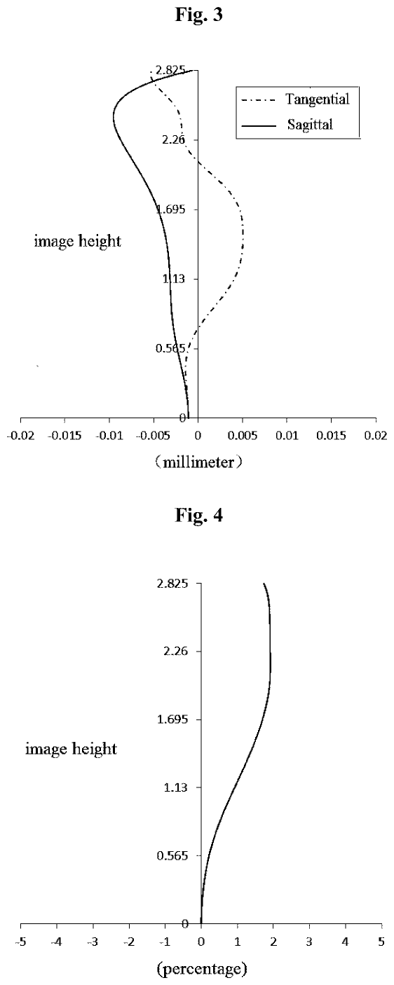

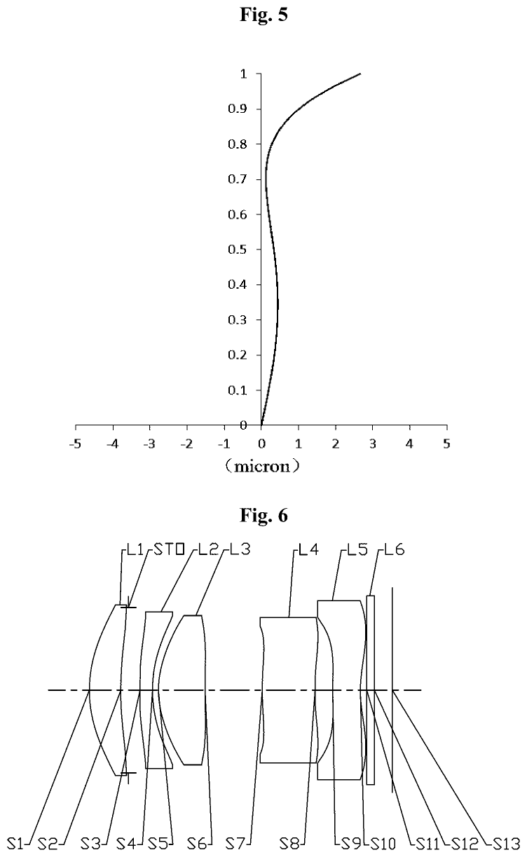

FIG. 2 shows a longitudinal aberration curve of the optical imaging lens assembly according to Example 1 to represent deviations of a convergence focal point after light with different wavelengths passes through the optical imaging lens assembly, such that image focal surfaces of the light with different wavelengths cannot overlap during final imaging and polychromatic light is diverged to form chromatic dispersions. FIG. 3 shows an astigmatism curve of the optical imaging lens assembly according to Example 1 to represent a tangential image surface curvature and a sagittal image surface curvature. FIG. 4 shows a distortion curve of the optical imaging lens assembly according to Example 1 to represent distortion values corresponding to different fields of view. FIG. 5 shows a lateral color curve of the optical imaging lens assembly according to Example 1 to represent aberrations at different image heights on the imaging surface after the light passes through the optical imaging lens assembly. It can be seen from FIGS. 2-5 that the optical imaging lens assembly according to Example 1 is applicable to a portable electronic product and has a large aperture and high imaging quality.

### Example 2

As shown in FIG. 6, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a convex surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 4 shows a surface type, curvature radius, thickness, material and conic coefficient of each lens of the optical imaging lens assembly according to Example 2, wherein the units of the curvature radius and the thickness are all millimeters.

TABLE 4
Detailed Optical Data of Each Lens in Example 2

| | | | | Material | |
|---|---|---|---|---|---|
| | | | | (refrac- | |
| | | | | tive | |
| | | | | index/ | Conic |
| Surface | Surface | Curvature | Thick- | Abbe | coef- |
| number | type | radius | ness | number) | ficient |
| OBJ | Spherical | Infinite | Infinite | | |
| S1 | Aspheric | 3.5698 | 0.8687 | 1.55/56.1 | −0.4158 |
| S2 | Aspheric | 11.2093 | 0.2122 | | −12.4867 |
| STO | Spherical | Infinite | 0.3184 | | |
| S3 | Aspheric | 50.0000 | 0.3458 | 1.64/23.5 | −99.0000 |
| S4 | Aspheric | 3.7856 | 0.1626 | | −8.3163 |
| S5 | Aspheric | 2.3701 | 1.2904 | 1.55/56.1 | −4.5080 |
| S6 | Aspheric | 22.0816 | 1.5805 | | 46.3471 |
| S7 | Aspheric | 8.5584 | 1.4580 | 1.64/23.5 | −7.4397 |
| S8 | Aspheric | 7.4684 | 0.4897 | | −10.9107 |
| S9 | Aspheric | 12.5547 | 0.7625 | 1.55/56.1 | 33.3237 |
| S10 | Aspheric | 3.2807 | 0.1798 | | −4.2596 |
| S11 | Spherical | Infinite | 0.2100 | 1.52/64.2 | |
| S12 | Spherical | Infinite | 0.4959 | | |
| S13 | Spherical | Infinite | | | |

Table 5 shows high-order coefficients that may be used for each aspheric surface of each aspheric lens in the example.

TABLE 5
High-Order Coefficients of Each Aspheric Surface in Example 2

| Surface | | | | | | | | | |
|---|---|---|---|---|---|---|---|---|---|
| number | A4 | A6 | A8 | A10 | A12 | A14 | A16 | A18 | A20 |
| S1 | −2.7980E−04 | 2.2788E−04 | −1.3693E−03 | 9.2292E−04 | −3.5593E−04 | 8.2820E−05 | −1.1529E−06 | 8.9185E−07 | −2.9398E−08 |
| S2 | 1.2120E−02 | −8.6 [symbol] 57E−03 | 2.0412E−03 | 1.9104E−04 | −3.5597E−04 | 1.3204E−04 | −2.4696E−05 | 2.3934E−08 | −9.5453E−08 |
| S3 | 5.5109E−02 | −4.8352E−02 | 2.7219E−02 | −1.1066E−02 | 2.8723E−03 | −4.3998E−04 | 3.2991E−05 | −3.1705E−07 | −7.0429E−08 |
| S4 | 4.1740E−02 | −4.1576E−02 | 3.2074E−02 | −1.4967E−02 | 4.0384E−03 | −5.6298E−04 | 1.7743E−05 | 4.5679E−05 | −4.0478E−07 |
| S5 | 7.2504E−04 | −2.1763E−03 | 4.1040E−03 | −1.6230E−03 | −3.3733E−06 | 1.7461E−04 | −5.1686E−06 | 6.4939E−08 | −3.1133E−07 |
| S6 | −1.4656E−02 | −2.8239E−04 | 1.1064E−03 | −7.8373E−04 | 3.8704E−04 | −1.3016E−04 | 2.8464E−05 | −3.5696E−08 | 1.9230E−07 |
| S7 | −1.4881E−02 | −1.8340E−03 | −3.6378E−04 | 4.8697E−05 | −1.6852E−05 | 4.5844E−08 | 0.0000E+00 | 0.0000E+00 | 0.0000E−00 |
| S8 | −1.0649E−02 | 1.8185E−03 | −2.5861E−03 | 2.4344E−03 | −1.8448E−03 | 8.80 [symbol] 2E−04 | −2.3326E−04 | 3.3911E−08 | 2.0262E−08 |
| S9 | −6.8733E−02 | 2.5163E−02 | −2.3026E−02 | 2.1418E−02 | −1.3384E−02 | 5.1723E−03 | −1.2068E−03 | 1.5572E−04 | −8.5152E−08 |
| S10 | −4.9644E−02 | 1.6605E−02 | 6.9722E−03 | 3.0464E−03 | −1.0574E−02 | 2.4665E−04 | −3.5506E−05 | 2.8446E−08 | −9.7117E−08 |

[symbol]

indicates data missing or illegible when filed

Table 6 shows an effective focal length f of the optical imaging lens assembly in Example 1, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 6
Parameters of the Optical Imaging Lens Assembly

| | |
|---|---|
| TTL (mm) | 8.37 |
| ImgH (mm) | 2.83 |
| f (mm) | 6.61 |
| f1 (mm) | 9.22 |
| f2 (mm) | −6.37 |
| f3 (mm) | 4.75 |
| f4 (mm) | −191.23 |
| f5 (mm) | −8.38 |

Specific values of each conditional expression in the example refer to Table 34.

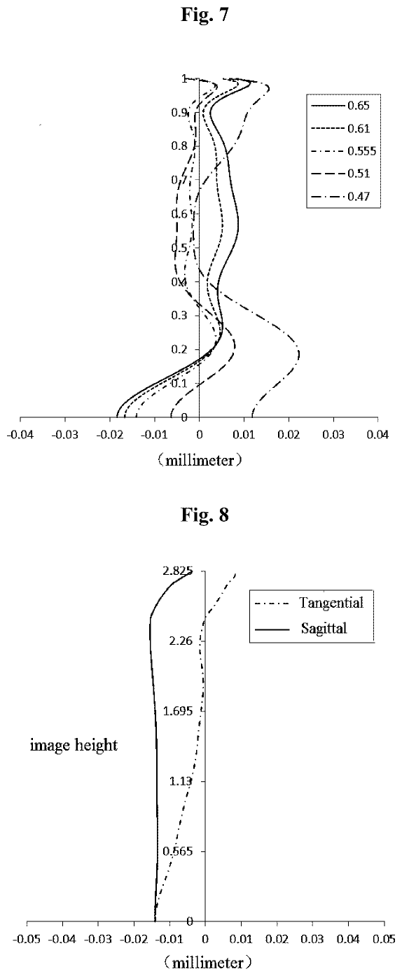

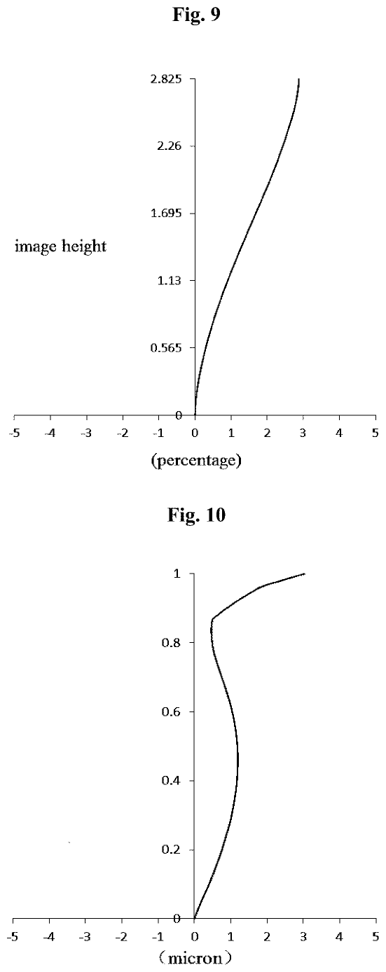

FIG. 7 shows a longitudinal aberration curve of the optical imaging lens assembly according to Example 2 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 8 shows an astigmatism curve of the optical imaging lens assembly according to Example 2 to represent a tangential image surface curvature and a sagittal image surface curvature. FIG. 9 shows a distortion curve of the optical imaging lens assembly according to Example 2 to represent distortion values corresponding to different fields of view. FIG. 10 shows a lateral color curve of the optical imaging lens assembly according to Example 2 to represent aberrations at different image heights on the imaging surface after the light passes through the optical imaging lens assembly. It can be seen from FIGS. 7-10 that the optical imaging lens assembly according to Example 2 is applicable to a portable electronic product and has a large aperture and high imaging quality.

### Example 3

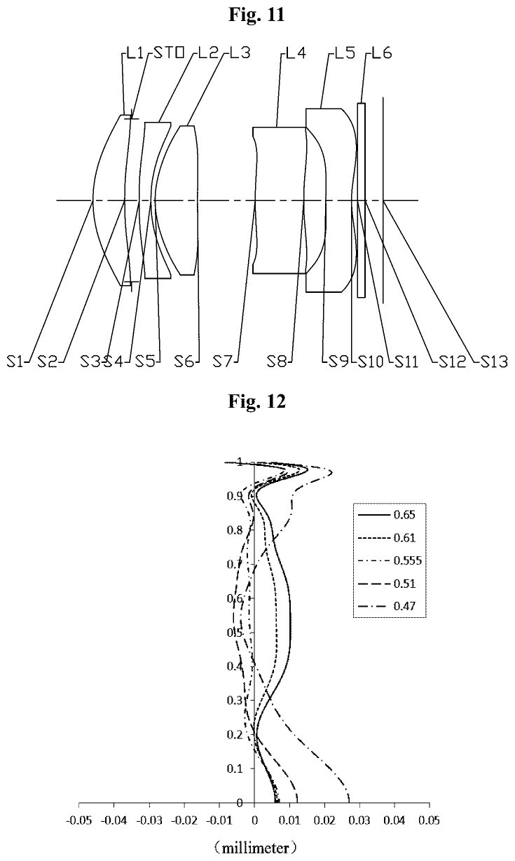

As shown in FIG. 11, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a convex surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 7 shows a surface type, curvature radius, thickness, material and conic coefficient of each lens of the optical imaging lens assembly according to Example 3, wherein the units of the curvature radius and the thickness are all millimeters.

TABLE 7
Detailed Optical Data of Each Lens in Example 3

| | | | | Material | |
|---|---|---|---|---|---|
| | | | | (refrac- | |
| | | | | tive | |
| | | | | index/ | Conic |
| Surface | Surface | Curvature | Thick- | Abbe | coef- |
| number | type | radius | ness | number) | ficient |
| OBJ | Spherical | Infinite | Infinite | | |
| S1 | Aspheric | 3.4074 | 0.8730 | 1.55/56.1 | −0.4367 |
| S2 | Aspheric | 10.3083 | 0.1938 | | −13.9648 |
| STO | Spherical | Infinite | 0.2124 | | |
| S3 | Aspheric | 50.0000 | 0.3188 | 1.64/23.5 | −99.0000 |
| S4 | Aspheric | 3.9580 | 0.1160 | | −7.8832 |
| S5 | Aspheric | 2.4620 | 1.1712 | 1.55/56.1 | −4.5152 |
| S6 | Aspheric | 22.6142 | 1.5916 | | 47.0189 |
| S7 | Aspheric | 8.0133 | 1.3400 | 1.64/23.5 | −8.8207 |
| S8 | Aspheric | 7.1919 | 0.6090 | | −10.4024 |
| S9 | Aspheric | 11.8554 | 0.7102 | 1.55/56.1 | 31.2586 |
| S10 | Aspheric | 3.1873 | 0.1639 | | −4.8609 |
| S11 | Spherical | Infinite | 0.2100 | 1.52/64.2 | |
| S12 | Spherical | Infinite | 0.4955 | | |
| S13 | Spherical | Infinite | | | |

Table 8 shows high-order coefficients that may be used for each aspheric surface of each aspheric lens in the example.

TABLE 8
High-Order Coefficients of Each Aspheric Surface in Example 3

| Surface | | | | | | | | | |
|---|---|---|---|---|---|---|---|---|---|
| number | A4 | A6 | A8 | A10 | A12 | A14 | A16 | A18 | A20 |
| S1 | −3.0698E−05 | −2.0413E−03 | 1.9972E−03 | −1.5518E−03 | 7.1100E−04 | −1.9817E−04 | 3.2772E−05 | −2.9408E−06 | 1.1034E−07 |
| S2 | 1.0000E−02 | −4.9717E−03 | −1.1262E−03 | 1.8323E−03 | −8.9724E−04 | 2.4762E−04 | −4.0406E−05 | 3.6633E−06 | −1.4337E−07 |
| S3 | 5.4570E−02 | −4.2102E−02 | 2.1655E−02 | −7.5846E−03 | 1.6022E−03 | −1.6022E−04 | −2.9654E−08 | 2.1137E−06 | −1.3621E−07 |
| S4 | 4.0862E−02 | −3.6780E−02 | 2.6130E−02 | −1.1838E−02 | 3.2648E−03 | −6.1166E−04 | 8.1743E−05 | −7.7587E−06 | 3.8378E−07 |
| S5 | 7.8286E−04 | −4.2637E−03 | 8.8517E−03 | −6.4614E−03 | 2.9685E−03 | −9.2624E−04 | 1.8591E−04 | −2.1152E−05 | 1.0193E−08 |
| S6 | −1.4119E−02 | 1.2786E−03 | −1.1021E−03 | 6.1338E−04 | −6.4385E−06 | −7.3536E−05 | 3.3799E−06 | −5.7039E−06 | 3.4652E−07 |
| S7 | −1.4706E−02 | −2.1080E−03 | −2.3457E−05 | −2.9780E−04 | 8.4570E−06 | −7.1412E−06 | 0.0000E+00 | 0.0000E+00 | 0.0000E+00 |
| S8 | −1.2413E−02 | 3.9172E−03 | −4.5938E−03 | 3.8672E−03 | −2.6005E−03 | 1.1459E−03 | −3.0544E−04 | 4.4662E−05 | −2.7071E−06 |
| S9 | −8.0643E−02 | 2.9660E−02 | −2.8102E−02 | 2.6501E−02 | −1.6835E−02 | 8.6695E−03 | −1.6139E−03 | 2.1606E−04 | −2.2253E−05 |
| S10 | −5.3916E−02 | 1.8310E−02 | −8.0511E−03 | 3.5572E−03 | −1.2542E−03 | 2.9777E−04 | −4.3902E−06 | 3.6290E−06 | −1.2886E−07 |

Table 9 shows an effective focal length f of the optical imaging lens assembly in Example 3, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 9
Parameters of the Optical Imaging Lens Assembly

| | |
|---|---|
| TTL (mm) | 8.01 |
| ImgH (mm) | 2.83 |
| f (mm) | 6.50 |
| f1 (mm) | 8.92 |
| f2 (mm) | −6.69 |
| f3 (mm) | 4.96 |
| f4 (mm) | −301.79 |
| f5 (mm) | −8.22 |

Specific values of each conditional expression in the example refer to Table 34.

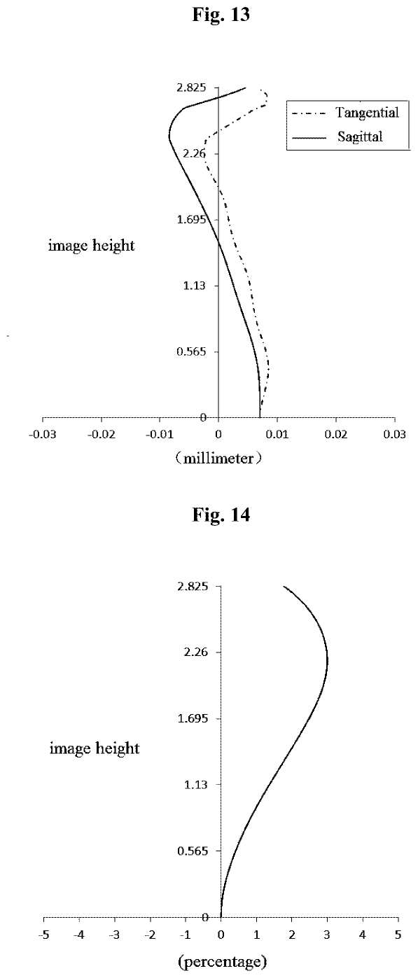

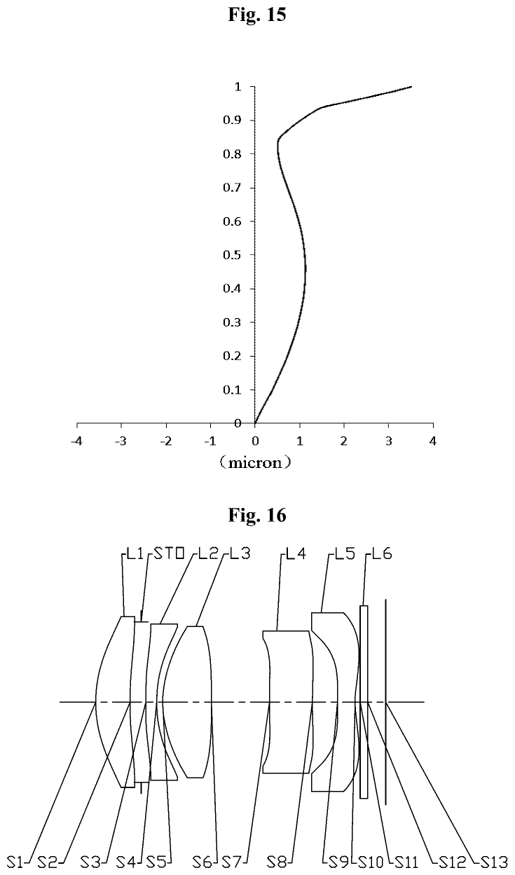

FIG. 12 shows a longitudinal aberration curve of the optical imaging lens assembly according to Example 3 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 13 shows an astigmatism curve of the optical imaging lens assembly according to Example 3 to represent a tangential image surface curvature and a sagittal image surface curvature. FIG. 14 shows a distortion curve of the optical imaging lens assembly according to Example 3 to represent distortion values corresponding to different fields of view. FIG. 15 shows a lateral color curve of the optical imaging lens assembly according to Example 3 to represent aberrations at different image heights on the imaging surface after the light passes through the optical imaging lens assembly. It can be seen from FIGS. 12-15 that the optical imaging lens assembly according to Example 3 is applicable to a portable electronic product and has a large aperture and high imaging quality.

### Example 4

As shown in FIG. 16, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a convex surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a convex surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 10 shows a surface type, curvature radius, thickness, material and conic coefficient of each lens of the optical imaging lens assembly according to Example 4, wherein the units of the curvature radius and the thickness are all millimeters.

TABLE 10
Detailed Optical Data of Each Lens in Example 4

| | | | | Material | |
|---|---|---|---|---|---|
| | | | | (refrac- | |
| | | | | tive | |
| | | | | index/ | Conic |
| Surface | Surface | Curvature | Thick- | Abbe | coef- |
| number | type | radius | ness | number) | ficient |
| OBJ | Spherical | Infinite | Infinite | | |
| S1 | Aspheric | 3.5372 | 0.9487 | 1.55/56.1 | −0.4879 |
| S2 | Aspheric | 12.6641 | 0.3064 | | −13.3121 |
| STO | Spherical | Infinite | 0.1303 | | |
| S3 | Aspheric | 50.0000 | 0.3000 | 1.64/23.5 | −99.0000 |
| S4 | Aspheric | 3.9827 | 0.1637 | | −7.1173 |
| S5 | Aspheric | 2.7065 | 1.3465 | 1.55/56.1 | −4.3520 |
| S6 | Aspheric | −50.0000 | 1.5998 | | −99.0000 |
| S7 | Aspheric | 15.7253 | 1.1866 | 1.64/23.5 | −48.0760 |
| S8 | Aspheric | 13.9455 | 0.6925 | | −43.7559 |
| S9 | Aspheric | 20.2447 | 0.4850 | 1.55/56.1 | 49.6946 |
| S10 | Aspheric | 2.8990 | 0.1404 | | −6.9693 |
| S11 | Spherical | Infinite | 0.2100 | 1.52/64.2 | |
| S12 | Spherical | Infinite | 0.4955 | | |
| S13 | Spherical | Infinite | | | |

Table 11 shows high-order coefficients that may be used for each aspheric surface of each aspheric lens in the example.

TABLE 11
High-Order Coefficients of Each Aspheric Surface in Example 4

| Surface | | | | | | | | | |
|---|---|---|---|---|---|---|---|---|---|
| number | A4 | A6 | A8 | A10 | A12 | A14 | A16 | A18 | A20 |
| S1 | −6.3157E−04 | −1.9753E−04 | −4.7258E−04 | 2.3774E−04 | −8.2533E−05 | 1.8665E−05 | −2.6780E−06 | 2.2614E−07 | −8.0021E−09 |
| S2 | 1.0232E−02 | −3.8867E−03 | −2.8862E−03 | 3.0264E−03 | −1.4214E−03 | 3.9826E−04 | −6.8184E−05 | 6.1105E−08 | −2.3885E−07 |
| S3 | 5.0538E−02 | −3.8354E−02 | 2.0073E−02 | −7.9317E−03 | 2.2960E−03 | −4.8369E−04 | 7.1501E−05 | −6.5790E−06 | 2.7693E−07 |
| S4 | 4.0266E−02 | −3.5032E−02 | 2.6780E−02 | −1.4822E−02 | 6.0283E−03 | −1.7756E−03 | 3.4726E−04 | −3.9249E−05 | 1.9097E−06 |
| S5 | 6.0645E−04 | −2.6092E−03 | 7.8305E−03 | −6.3933E−03 | 3.2983E−03 | −1.0932E−03 | 2.2152E−04 | −2.4974E−05 | 1.1487E−08 |
| S8 | −1.1638E−02 | −1.2054E−03 | 2.5978E−03 | −2.5807E−03 | 1.5761E−03 | −5.8552E−04 | 1.2887E−04 | −1.5377E−05 | 7.6303E−07 |
| S7 | −1.8369E−02 | −3.7604E−03 | 1.1647E−03 | −6.7715E−04 | 2.6862E−04 | −2.5291E−05 | 0.0000E+00 | 0.0000E+00 | 0.0000E+00 |
| S8 | −1.4148E−02 | 1.7040E−03 | −3.3632E−03 | 2.4862E−03 | −1.4156E−03 | 5.6957E−04 | −1.4291E−04 | 2.0103E−05 | −1.1674E−08 |
| S9 | −1.1237E−01 | 4.6440E−02 | −2.7039E−02 | 1.5542E−02 | −7.3332E−03 | 2.3931E−03 | −4.9178E−04 | 5.7616E−05 | −2.9187E−06 |
| S10 | −8.0282E−02 | 4.3815E−02 | −2.3896E−02 | 1.0290E−02 | −3.2210E−03 | 6.8513E−04 | −9.2659E−05 | 7.1531E−06 | −2.3999E−07 |

Table 12 shows an effective focal length f of the optical imaging lens assembly in Example 4, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 12
Parameters of the Optical Imaging Lens A

| | | |
|---|---|---|
| TTL | (mm) | 8.01 |
| ImgH | (mm) | 2.83 |
| f | (mm) | 6.51 |
| f1 | (mm) | 8.67 |
| f2 | (mm) | −6.73 |
| f3 | (mm) | 4.75 |
| f4 | (mm) | −258.77 |
| f5 | (mm) | −6.26 |

Specific values of each conditional expression in the example refer to Table 34.

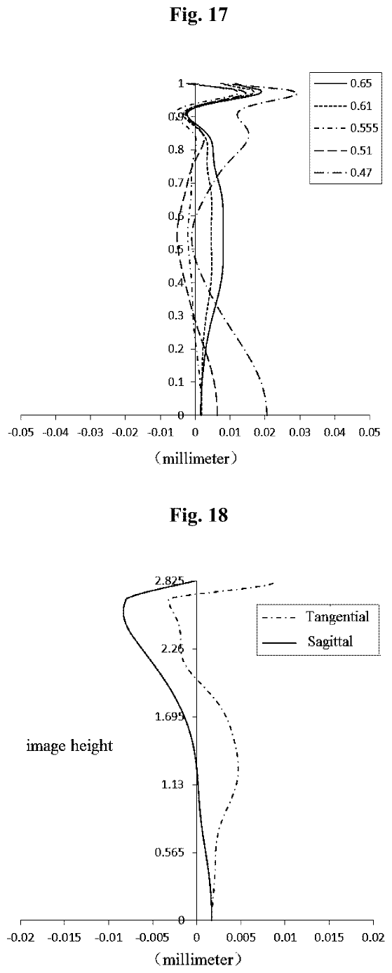

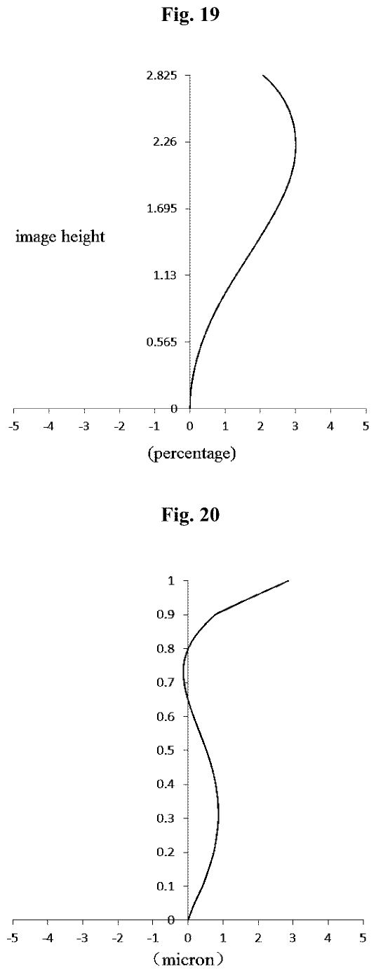

FIG. 17 shows a longitudinal aberration curve of the optical imaging lens assembly according to Example 4 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 18 shows an astigmatism curve of the optical imaging lens assembly according to Example 4 to represent a tangential image surface curvature and a sagittal image surface curvature. FIG. 19 shows a distortion curve of the optical imaging lens assembly according to Example 4 to represent distortion values corresponding to different fields of view. FIG. 20 shows a lateral color curve of the optical imaging lens assembly according to Example 4 to represent aberrations at different image heights on the imaging surface after the light passes through the optical imaging lens assembly. It can be seen from FIGS. 17-20 that the optical imaging lens assembly according to Example 4 is applicable to a portable electronic product and has a large aperture and high imaging quality.

### Example 5

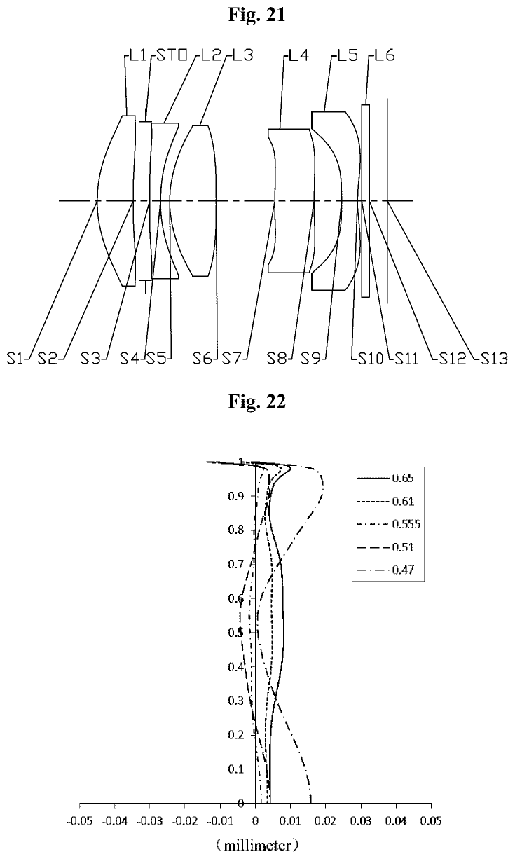

As shown in FIG. 21, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a concave surface, and an image-side surface S4 of the second lens is a concave surface. The third lens L3 has a positive refractive power, an object-side surface S5 of the third lens is a convex surface, and an image-side surface S6 of the third lens is a convex surface. The fourth lens L4 has a positive refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 13 shows a surface type, curvature radius, thickness, material and conic coefficient of each lens of the optical imaging lens assembly according to Example 5, wherein the units of the curvature radius and the thickness are all millimeters.

TABLE 13
Detailed Optical Data of Each Lens in Example 5

| | | | | Material | |
|---|---|---|---|---|---|
| Surface | Surface | Curvature | Thick− | (refractive index/ | Conic |
| number | type | radius | ness | Abbe number) | coefficient |
| OBJ | Spherical | Infinite | Infinite | | |
| S1 | Aspheric | 3.6052 | 0.9905 | 1.55/56.1 | −0.4606 |
| S2 | Aspheric | 21.3306 | 0.3427 | | −20.7355 |
| STO | Spherical | Infinite | 0.1148 | | |
| S3 | Aspheric | −40.0672 | 0.3000 | 1.64/23.5 | −99.0000 |
| S4 | Aspheric | 4.9809 | 0.2507 | | −8.1815 |
| S5 | Aspheric | 2.9718 | 1.2838 | 1.55/56.1 | −4.3451 |
| S6 | Aspheric | −50.0000 | 1.6173 | | −99.0000 |
| S7 | Aspheric | 12.7396 | 1.0844 | 1.64/23.5 | −54.5265 |
| S8 | Aspheric | 13.7396 | 0.7612 | | −59.6825 |
| S9 | Aspheric | −28.4864 | 0.4371 | 1.55/56.1 | −99.0000 |
| S10 | Aspheric | 3.5360 | 0.1174 | | −8.2886 |
| S11 | Spherical | Infinite | 0.2100 | 1.52/64.2 | |
| S12 | Spherical | Infinite | 0.4955 | | |
| S13 | Spherical | infinite | | | |

Table 14 shows high-order coefficients that can be used for each aspheric surface of each aspheric lens in the example.

TABLE 14
High-Order Coefficients of Each Aspheric Surface in Example 5

| Surface | | | | | | | | | |
|---|---|---|---|---|---|---|---|---|---|
| number | A4 | A6 | A8 | A10 | A12 | A14 | A16 | A18 | A20 |
| S1 | − [symbol] .9037E−04 | −4.1633E−04 | −2.5808E−05 | −8.4163E−05 | 5.7339E−05 | −1.8588E−05 | 3.2144E−08 | −2.8401E−07 | 1.0582E−08 |
| S2 | 8.3356E−03 | −3.3672E−03 | −1.6275E−03 | 1.8062E−03 | −8.1119E−04 | 2.1094E−04 | −3.2514E−05 | 2.7639E−06 | −9.9569E−08 |
| S3 | 4.7747E−02 | −3.4098E−02 | 1.6033E−02 | −4.8780E−03 | 7.3171E−04 | 1.8879E−05 | 2.5515E−05 | 3.7056E−06 | −1.8369E−07 |
| S4 | 3.7687E−02 | −2.7739E−02 | 1.5495E−02 | −4.6398E−03 | 3.2283E−04 | 2.1305E−04 | −6.9521E−05 | 8.6972E−05 | −4.1392E−07 |
| S5 | 1.5021E−04 | 1.0190E−03 | 4.8611E−04 | 2.0409E−04 | −3.7888E−04 | 1.7660E−04 | −4.3062E−05 | 5.7195E−06 | −3.3186E−07 |
| S8 | −1.2396E−02 | 4.6857E−04 | 8.7678E−05 | −1.1511E−04 | 1.3363E−04 | −6.9206E−05 | 1.7967E−05 | −2.2786E−06 | 1.0588E−07 |
| S7 | −1.7487E−02 | −4.3516E−03 | 9.5911E−04 | −6.5765E−04 | 1.8569E−04 | −1.5775E−05 | 0.0000E+00 | 0.0000E+00 | 0.0000E−00 |
| S8 | −9.9324E−03 | −2.6267E−03 | 1.5863E−04 | −1.9480E−04 | 1.0176E−04 | −1.8964E−05 | 8.0296E−07 | 5.6671E−07 | −7.0463E−08 |
| S9 | −1.0029E−01 | 4.1632E−02 | −2.2825E−02 | 1.1983E−02 | −5.4622E−03 | 1.7382E−03 | −3.4679E−04 | 3.9993E−05 | −2.0753E−08 |
| S10 | −7.9770E−02 | 4.3069E−02 | −2.3068E−02 | 9.8469E−03 | −3.0789E−02 | 6.5680E−04 | −8.8904E−05 | 6.8402E−06 | −2.2773E−07 |

[symbol]

indicates data missing or illegible when filed

Table 15 shows an effective focal length f of the optical imaging lens assembly in Example 5, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 15
Parameters of the Optical Imaging Lens A

| | | |
|---|---|---|
| TTL | (mm) | 8.01 |
| ImgH | (mm) | 2.83 |
| f | (mm) | 6.53 |
| f1 | (mm) | 6.60 |
| f2 | (mm) | −62.16 |
| f3 | (mm) | 16.60 |
| f4 | (mm) | 16.50 |
| f5 | (mm) | −14.98 |

Specific values of each conditional expression in the example refer to Table 34.

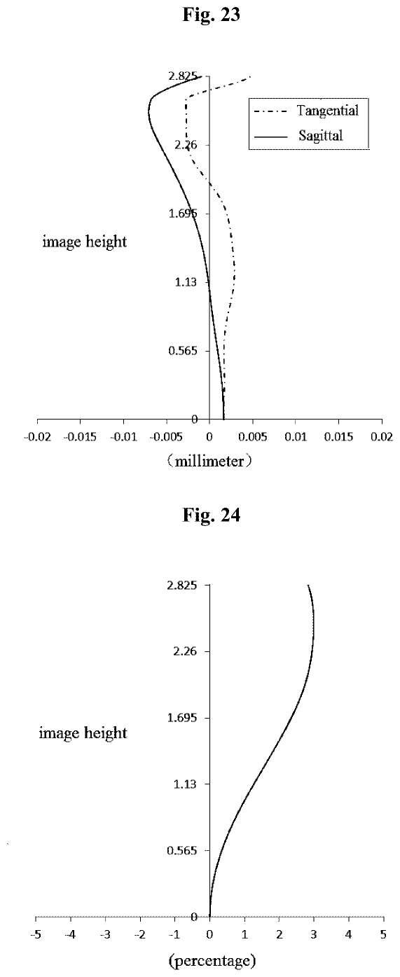

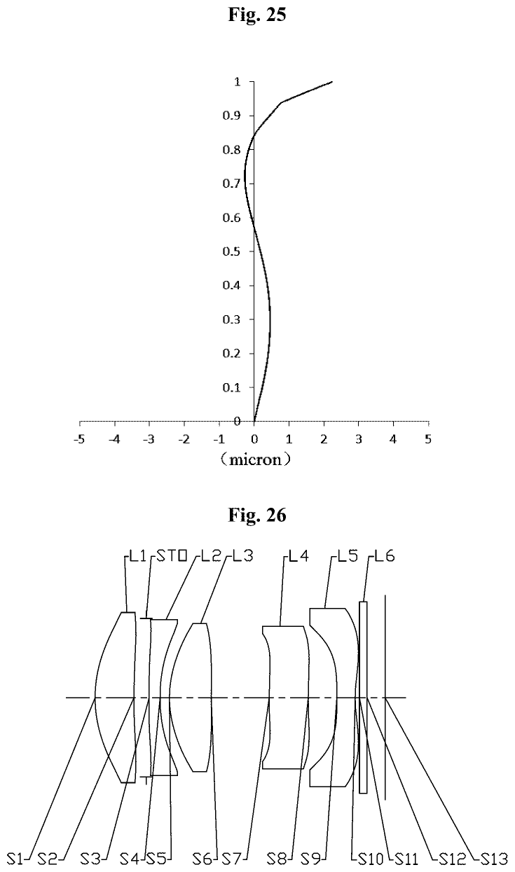

FIG. 22 shows a longitudinal aberration curve of the optical imaging lens assembly according to Example 5 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 23 shows an astigmatism curve of the optical imaging lens assembly according to Example 5 to represent a tangential image surface curvature and a sagittal image surface curvature. FIG. 24 shows a distortion curve of the optical imaging lens assembly according to Example 5 to represent distortion values corresponding to different fields of view. FIG. 25 shows a lateral color curve of the optical imaging lens assembly according to Example 5 to represent aberrations at different image heights on the imaging surface after the light passes through the optical imaging lens assembly. It can be seen from FIGS. 22 to 25 that the optical imaging lens assembly according to Example 5 is applicable to a portable electronic product and has a large aperture and high imaging quality.

### Example 6

As shown in FIG. 26, the optical imaging lens assembly sequentially includes, from an object side to an image side along an optical axis, a first lens L1, a diaphragm STO, a second lens L2, a third lens L3, a fourth lens L4, a fifth lens L5, an optical filter L6, and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a concave surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a positive refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 16 shows a surface type, curvature radius, thickness, material and conic coefficient of each lens of the optical imaging lens assembly according to Example 6, wherein the units of the curvature radius and the thickness are all millimeters.

TABLE 16
Detailed Optical Data of Each Lens in Example 6

| | | | | Material | |
|---|---|---|---|---|---|
| Surface | Surface | Curvature | Thick- | (refractive index/ | Conic |
| number | type | radius | ness | Abbe number) | coefficient |
| OBJ | Spherical | Infinite | Infinite | | |
| S1 | Aspheric | 3.5316 | 1.0725 | 1.55/56.1 | −0.4308 |
| S2 | Aspheric | 24.2334 | 0.3391 | | −38.1895 |
| STO | Spherical | Infinite | 0.0821 | | |
| S3 | Aspheric | −30.8429 | 0.3000 | 1.64/23.5 | −99.0000 |
| S4 | Aspheric | 5.0621 | 0.2581 | | −8.7579 |
| S5 | Aspheric | 2.8481 | 1.1545 | 1.55/56.1 | −4.1867 |
| S6 | Aspheric | 50.0000 | 1.6003 | | −34.8478 |
| S7 | Aspheric | 11.2433 | 1.0779 | 1.64/23.5 | −45.9214 |
| S8 | Aspheric | 13.7000 | 0.7878 | | −64.2304 |
| S9 | Aspheric | −50.0000 | 0.5060 | 1.55/56.1 | −99.0000 |
| S10 | Aspheric | 3.4852 | 0.1197 | | −6.0829 |
| S11 | Spherical | Infinite | 0.2100 | 1.52/64.2 | |
| S12 | Spherical | Infinite | 0.4975 | | |
| S13 | Spherical | Infinite | | | |

Table 17 shows high-order coefficients that can be used for each aspheric surface of each aspheric lens in the example.

TABLE 17
High-Order Coefficients of Each Aspheric Surface in Example 6

| Surface | | | | | | | | | |
|---|---|---|---|---|---|---|---|---|---|
| number | A4 | A6 | A8 | A10 | A12 | A14 | A16 | A18 | A20 |
| S1 | −7.6353E−04 | −2.6255E−04 | −1.7908E−04 | 5.6197E−05 | −1.0058E−05 | 3.1644E−07 | 9.4407E−08 | −2.6670E−09 | −3.7955E−10 |
| S2 | 8.5476E−00 | −4.1102E−03 | −1.1736E−03 | 1.6734E−03 | −7.9436E−04 | 2.1290E−04 | −3.3566E−05 | 2.9095E−08 | −1.0718E−07 |
| S3 | 4.8976E−02 | −3.6025E−02 | 1.7765E−02 | −5.9304E−03 | 1.1484E−03 | −8.4230E−06 | −9.9926E−08 | 2.3812E−08 | −1.336 [symbol] E−07 |
| S4 | 3.7384E−02 | −2.7661E−02 | 1.6000E−02 | −5.1830E−03 | 5.4782E−04 | 1.7569E−04 | −6.9333E−05 | 9.3223E−08 | −4.6364E−07 |
| S5 | −5.5315E−04 | 2.2858E−03 | −2.5349E−04 | 4.7477E−04 | −4.4696E−04 | 1.8890E−04 | −4.4579E−05 | 5.8608E−08 | −3.4269E−07 |
| S8 | −1.2668E−02 | 3.1966E−04 | 5.2202E−04 | −5.4807E−04 | 4.0695E−04 | −1.7850E−04 | 4.4700E−06 | −5.8648E−08 | 3.0539E−07 |
| S7 | −1.6188E−02 | −4.8528E−03 | 9.6131E−04 | −6.7178E−04 | 1.6428E−04 | −1.0425E−06 | 0.0000E+00 | 0.0000E+00 | 0.0000E+00 |
| S8 | −8.6621E−03 | −3.1133E−03 | 1.1446E−03 | −1.4496E−03 | 9.9241E−04 | −4.0024E−04 | 9.8481E−05 | −1.3110E−05 | 7.2662E−07 |
| S9 | −8.7633E−02 | 2.8889E−02 | −9.6864E−03 | 1.3868E−03 | 7.1600E−04 | −5.9645E−04 | 1.9394E−04 | −2.9407E−05 | 1.7024E−08 |
| S10 | −7.4800E−02 | 3.6831E−02 | −1.8609E−02 | 7.6136E−03 | −2.2996E−03 | 4.7377E−04 | −6.1788E−06 | 4.5723E−06 | −1.4836E−07 |

[symbol]

indicates data missing or illegible when filed

Table 18 shows an effective focal length f of the optical imaging lens assembly in Example 6, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 18
Parameters of the Optical Imaging Lens Assembly

| | | |
|---|---|---|
| TTL | (mm) | 8.01 |
| ImgH | (mm) | 2.83 |
| f | (mm) | 6.60 |
| f1 | (mm) | 7.43 |
| f2 | (mm) | −6.72 |
| f3 | (mm) | 5.48 |
| f4 | (mm) | 83.00 |
| f5 | (mm) | −5.95 |

Specific values of each conditional expression in the example refer to Table 34.

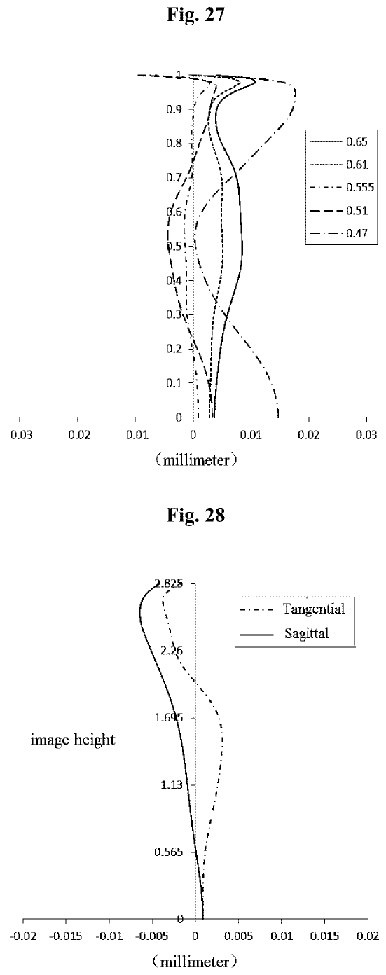

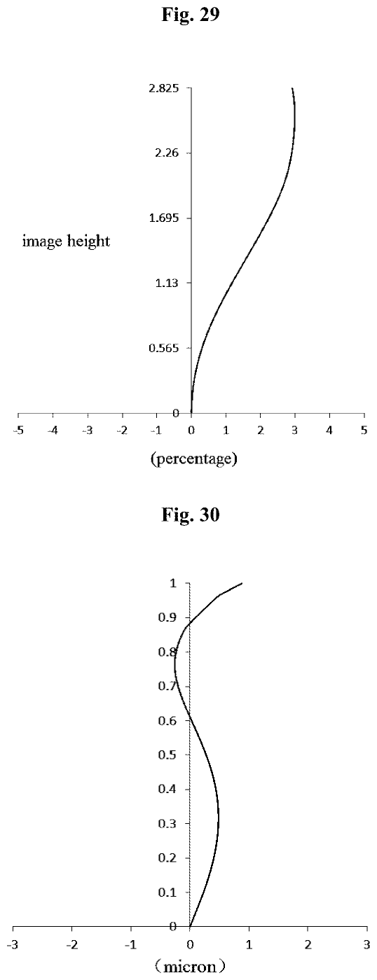

FIG. 27 shows a longitudinal aberration curve of the optical imaging lens assembly according to Example 6 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 28 shows an astigmatism curve of the optical imaging lens assembly according to Example 6 to represent a tangential image surface curvature and a sagittal image surface curvature. FIG. 29 shows a distortion curve of the optical imaging lens assembly according to Example 6 to represent distortion values corresponding to different fields of view. FIG. 30 shows a lateral color curve of the optical imaging lens assembly according to Example 6 to represent aberrations at different image heights on the imaging surface after the light passes through the optical imaging lens assembly. It can be seen from FIGS. 27 to 30 that the optical imaging lens assembly according to Example 6 is applicable to a portable electronic product and has a large aperture and high imaging quality.

### Example 7

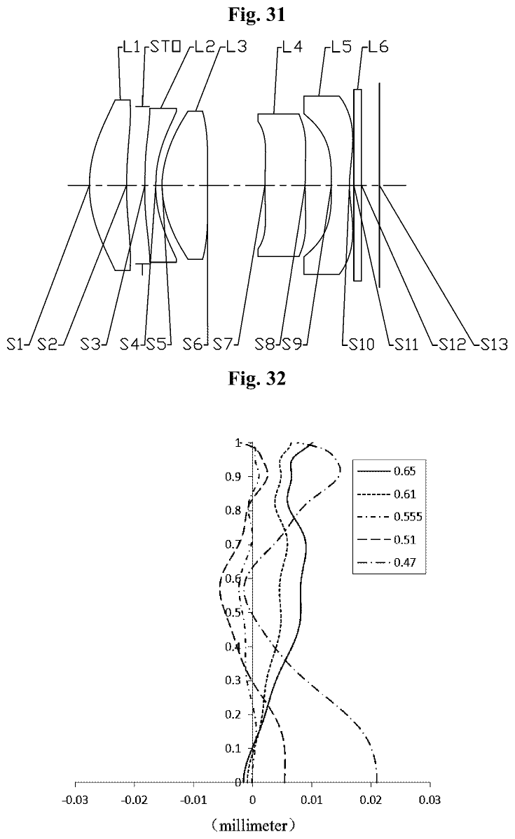

As shown in FIG. 31, the optical imaging lens assembly sequentially includes, from an object side to an image side along an optical axis, a first lens L1, a diaphragm STO, a second lens L2, a third lens L3, a fourth lens L4, a fifth lens L5, an optical filter L6, and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a positive refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 19 shows a surface type, curvature radius, thickness, material and conic coefficient of each lens of the optical imaging lens assembly according to Example 7, wherein the units of the curvature radius and the thickness are all millimeters.

TABLE 19
Detailed Optical Data of Each Lens in Example 7

| | | | | Material | |
|---|---|---|---|---|---|
| | | | | (refractive | |
| Surface | Surface | Curvature | Thick- | index/Abbe | Conic |
| number | type | radius | ness | number) | coefficient |
| OBJ | Spherical | Infinite | Infinite | | |
| S1 | Aspheric | 3.5245 | 1.0274 | 1.55/56.1 | −0.4667 |
| S2 | Aspheric | 13.3549 | 0.4386 | | −31.1733 |
| STO | Spherical | Infinite | 0.0656 | | |
| S3 | Aspheric | 50.0000 | 0.3000 | 1.64/23.5 | −99.0000 |
| S4 | Aspheric | 3.6536 | 0.1731 | | −7.6676 |
| S5 | Aspheric | 2.4109 | 1.2568 | 1.55/56.1 | −4.0438 |
| S6 | Aspheric | 50.0000 | 1.5827 | | −99.0000 |
| S7 | Aspheric | 12.7000 | 1.1093 | 1.64/23.5 | −50.1202 |
| S8 | Aspheric | 16.7303 | 0.7256 | | −86.5107 |
| S9 | Aspheric | −50.0000 | 0.4998 | 1.55/56.1 | 40.5017 |
| S10 | Aspheric | 3.4342 | 0.1211 | | −5.4482 |
| S11 | Spherical | Infinite | 0.2100 | 1.52/64.2 | |
| S12 | Spherical | Infinite | 0.4955 | | |
| S13 | Spherical | Infinite | | | |

Table 20 shows high-order coefficients that may be used for each aspheric surface of each aspheric lens in the example.

TABLE 20
High-Order Coefficients of Each Aspheric Surface in Example 7

| Surface | | | | | | | | | |
|---|---|---|---|---|---|---|---|---|---|
| number | A4 | A6 | A8 | A10 | A12 | A14 | A16 | A18 | A20 |
| S1 | −8.2296E−04 | 1.0633E−04 | −8.6672E−04 | 5.9742E−04 | −2.5461E−04 | 6.6415E−05 | −1.0463E−06 | 9.1771E−07 | −3.4137E−08 |
| S2 | 9.1587E−03 | −4.7910E−03 | −2.8094E−04 | 1.0400E−03 | −5.4011E−04 | 1.5022E−04 | −2.4010E−05 | 2.0765E−08 | −7.5235E−08 |
| S3 | 5.0269E−02 | −4.1156E−02 | 2.4494E−02 | −1.0926E−02 | 3.3967E−03 | −7.1465E−04 | 9.8354E−05 | −8.1092E−08 | 3.0579E−07 |
| S4 | 3.9443E−02 | −3.2669E−02 | 2.3749E−02 | −1.1466E−02 | 3.5746E−03 | −7.3848E−04 | 1.0204E−04 | −9.0570E−06 | 4.0069E−07 |
| S5 | −1.1490E−03 | 2.3978E−03 | 1.5772E−03 | −1.7239E−03 | 8.8155E−04 | −2.9849E−04 | 8.4159E−06 | −7.6316E−08 | 3.6910E−07 |
| S8 | −1.1824E−02 | −3.6801E−04 | 1.9124E−03 | −1.7592E−03 | 1.0781E−03 | −4.1486E−04 | 3.6098E−05 | −1.2172E−06 | 6.3884E−07 |
| S7 | −1.6353E−02 | −4.8387E−03 | 7.6332E−04 | −5.2472E−04 | 1.0948E−04 | −1.5486E−06 | 0.0000E+00 | 0.0000E+00 | 0.0000E+00 |
| S8 | −8.8158E−03 | −3.7756E−03 | 1.7326E−03 | −2.0760E−03 | 1.4062E−03 | −5.7617E−04 | 1.4352E−04 | −1.9406E−05 | 1.0910E−08 |
| S9 | −8.9784E−02 | 3.3449E−02 | −1.5288E−02 | 5.5723E−03 | −1.3242E−03 | 2.3467E−05 | 7.9811E−05 | −1.7776E−06 | 1.1765E−06 |
| S10 | −7.8349E−02 | 3.9895E−02 | −2.0501E−02 | 8.4234E−03 | −2.5338E−03 | 5.1796E−04 | −8.6886E−05 | 4.8889E−08 | −1.5418E−07 |

Table 21 shows an effective focal length f of the optical imaging lens assembly in Example 7, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 21
Parameters of the Optical Imaging Lens A

| | | |
|---|---|---|
| TTL | (mm) | 8.01 |
| ImgH | (mm) | 2.83 |
| f | (mm) | 6.55 |
| f1 | (mm) | 8.46 |
| f2 | (mm) | −6.13 |
| f3 | (mm) | 4.60 |
| f4 | (mm) | 73.82 |
| f5 | (mm) | −5.87 |

Specific values of each conditional expression in the example refer to Table 34.

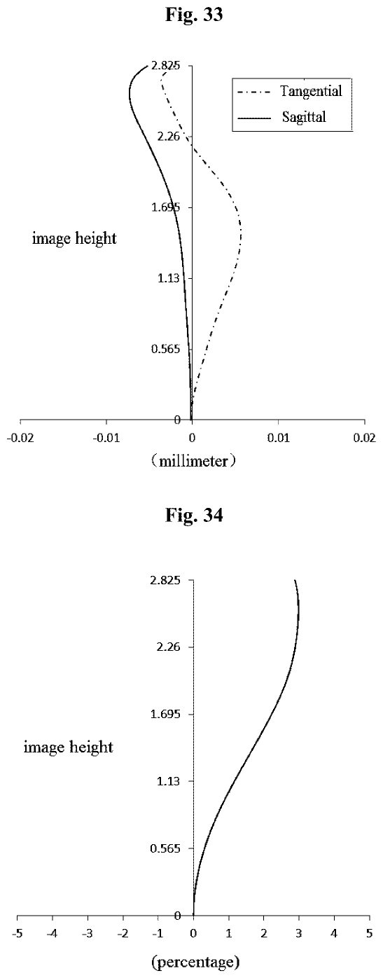

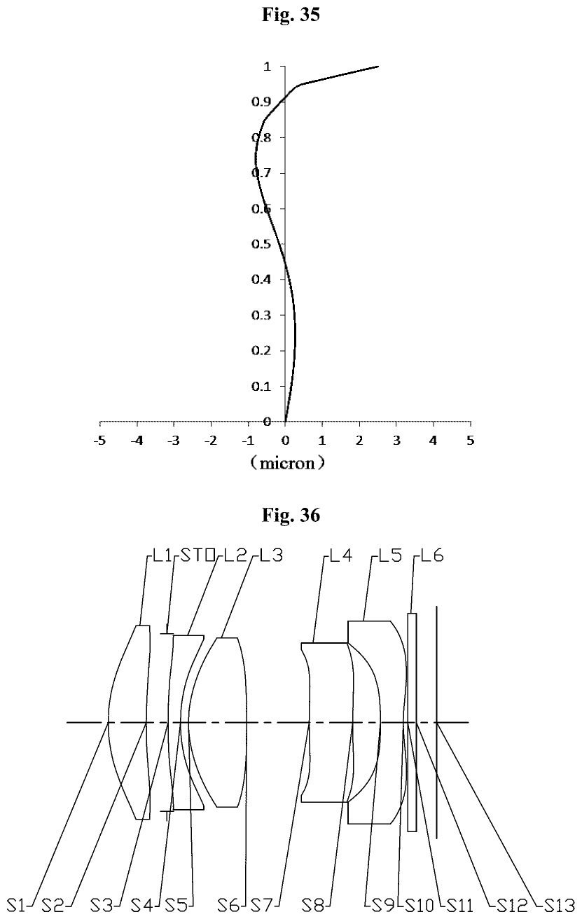

FIG. 32 shows a longitudinal aberration curve of the optical imaging lens assembly according to Example 7 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 33 shows an astigmatism curve of the optical imaging lens assembly according to Example 7 to represent a tangential image surface curvature and a sagittal image surface curvature. FIG. 34 shows a distortion curve of the optical imaging lens assembly according to Example 7 to represent distortion values corresponding to different fields of view. FIG. 35 shows a lateral color curve of the optical imaging lens assembly according to Example 7 to represent aberrations at different image heights on the imaging surface after the light passes through the optical imaging lens assembly. It can be seen from FIGS. 32-35 that the optical imaging lens assembly according to Example 7 is applicable to a portable electronic product and has a large aperture and high imaging quality.

### Example 8

As shown in FIG. 36, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a convex surface. The fourth lens L4 has a positive refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 22 shows a surface type, curvature radius, thickness, material and conic coefficient of each lens of the optical imaging lens assembly according to Example 8, wherein the units of the curvature radius and the thickness are all millimeters.

TABLE 22
Detailed Optical Data of Each Lens in Example 8

| | | | | Material | |
|---|---|---|---|---|---|
| Surface | Surface | Curvature | Thick- | (refractive index/ | Conic |
| number | type | radius | ness | Abbe number) | coefficient |
| OBJ | Spherical | Infinite | Infinite | | |
| S1 | Aspheric | 3.6110 | 0.9285 | 1.55/56.1 | −0.4835 |
| S2 | Aspheric | 15.9814 | 0.5016 | | −26.0320 |
| STO | Spherical | Infinite | 0.0300 | | |
| S3 | Aspheric | 50.0000 | 0.3000 | 1.64/23.5 | −99.0000 |
| S4 | Aspheric | 3.9145 | 0.1932 | | −7.0116 |
| S5 | Aspheric | 2.7062 | 1.4158 | 1.55/56.1 | −3.8612 |
| S6 | Aspheric | −50.0000 | 1.5234 | | −70.3196 |
| S7 | Aspheric | 12.7000 | 1.0581 | 1.64/23.5 | −61.4039 |
| S8 | Aspheric | 13.7000 | 0.6752 | | −80.1296 |
| S9 | Aspheric | −15.7038 | 0.5568 | 1.55/56.1 | −35.3272 |
| S10 | Aspheric | 3.8590 | 0.1073 | | −3.7436 |
| S11 | Spherical | Infinite | 0.2100 | 1.52/64.2 | |
| S12 | Spherical | Infinite | 0.4960 | | |
| S13 | Spherical | Infinite | | | |

Table 23 shows high-order coefficients that may be used for each aspheric surface of each aspheric lens in the example.

TABLE 23
High-Order Coefficients of Each Aspheric Surface in Example 8

| Surface | | | | | | | | | |
|---|---|---|---|---|---|---|---|---|---|
| number | A4 | A6 | A8 | A10 | A12 | A14 | A16 | A18 | A20 |
| S1 | − [symbol] .8389E−04 | 1.3254E−04 | −8.8296E−04 | 5.9974E−04 | −2.8148E−04 | 7.0448E−05 | −1.1517E−06 | 1.0487E−08 | −4.0556E−08 |
| S2 | 8.3145E−03 | −4.0608E−03 | 2.1073E−05 | 5.1619E−04 | −2.6483E−04 | 7.0605E−05 | −1.0838E−05 | 8.5541E−07 | −2.8336E−08 |
| S3 | 4.4869E−02 | −3.4678E−02 | 2.0452E−02 | −9.3551E−03 | 2.9824E−03 | −6.3437E−04 | 8.8008E−06 | −6.7522E−06 | 2.3023E−07 |
| S4 | 3.8282E−02 | −2.9096E−02 | 2.0704E−02 | −9.9849E−03 | 3.0598E−03 | −5.9321E−04 | 7.0201E−05 | −4.8266E−08 | 1.2702E−07 |
| S5 | 3.1366E−04 | 2.0418E−00 | 7.5547E−04 | −2.0490E−04 | −2.8335E−04 | 2.0572E−04 | −5.8898E−05 | 8.7083E−08 | −5.2286E−07 |
| S8 | −1.2113E−02 | −5.7066E−04 | 1.5444E−03 | −1.3347E−03 | 7.4833E−04 | −2.5987E−04 | 5.4072E−05 | −6.0887E−08 | 2.7588E−07 |
| S7 | −1.7655E−02 | −4.2125E−03 | 3.9875E−04 | −3.0388E−04 | 7.8308E−05 | −2.2389E−06 | 0.0000E+00 | 0.0000E+00 | 0.0000E+00 |
| S8 | − [symbol] .8603E−03 | −3.4717E−03 | 1.3833E−03 | −1.5288E−03 | 9.2476E−04 | −3.2629E−04 | 8.9428E−05 | −8.0080E−08 | 3.3413E−07 |
| S9 | −8.5863E−02 | 3.4183E−02 | −2.3495E−02 | 1.6636E−02 | −9.4202E−03 | 3.5492E−03 | −8.2537E−04 | 1.0851E−04 | −8.2053E−08 |
| S10 | −7.6957E−02 | 3.6848E−02 | −1.8778E−02 | 7.8988E−03 | −2.4880E−02 | 5.2651E−04 | −7.1283E−05 | 5.4765E−08 | −1.8174E−07 |

[symbol]

indicates data missing or illegible when filed

Table 24 shows an effective focal length f of the optical imaging lens assembly in Example 8, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

Parameters of the Optical Imaging Lens A

| | | |
|---|---|---|
| TTL | (mm) | 8.00 |
| ImgH | (mm) | 2.83 |
| f | (mm) | 6.49 |
| f1 | (mm) | 8.32 |
| f2 | (mm) | −6.61 |
| f3 | (mm) | 4.75 |
| f4 | (mm) | 190.80 |
| f5 | (mm) | −5.62 |

Specific values of each conditional expression in the example refer to Table 34.

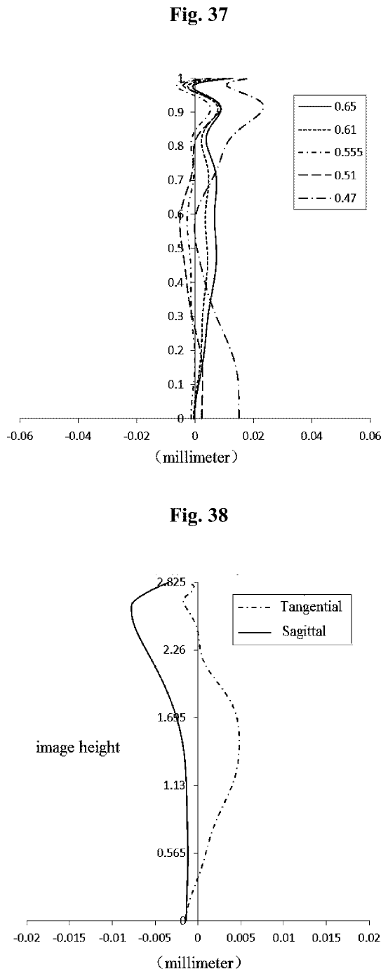

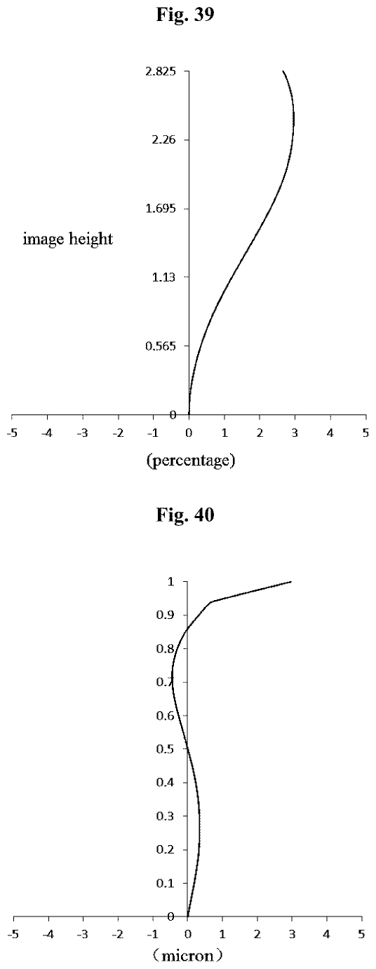

FIG. 37 shows a longitudinal aberration curve of the optical imaging lens assembly according to Example 8 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 38 shows an astigmatism curve of the optical imaging lens assembly according to Example 8 to represent a tangential image surface curvature and a sagittal image surface curvature FIG. 39 shows a distortion curve of the optical imaging lens assembly according to Example 8 to represent distortion values corresponding to different fields of view. FIG. 40 shows a lateral color curve of the optical imaging lens assembly according to Example 8 to represent aberrations at different image heights on the imaging surface after the light passes through the optical imaging lens assembly. It can be seen from FIGS. 37-40 that the optical imaging lens assembly according to Example 8 is applicable to a portable electronic product and has a large aperture and high imaging quality.

### Example 9

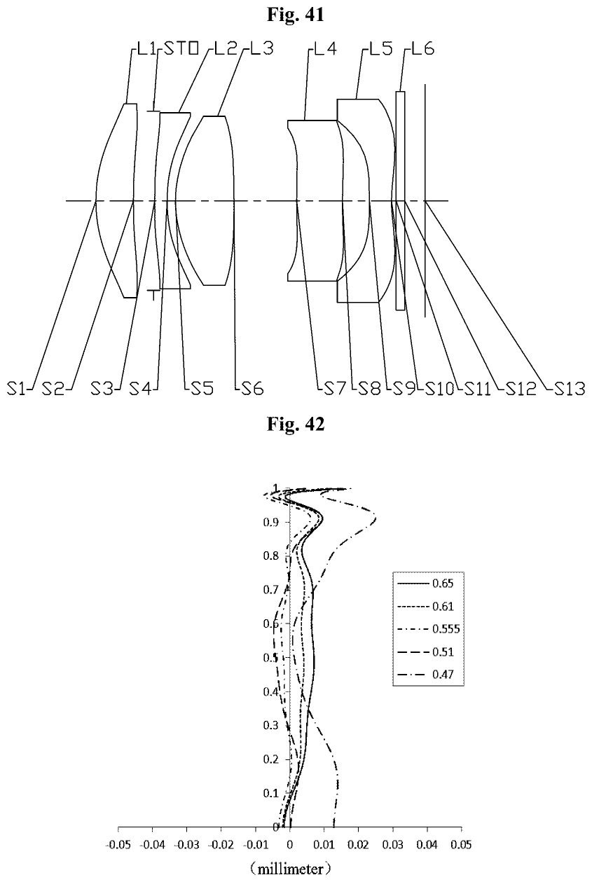

As shown in FIG. 41, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a convex surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 25 shows a surface type, curvature radius, thickness, material and conic coefficient of each lens of the optical imaging lens assembly according to Example 9, wherein the units of the curvature radius and the thickness are all millimeters.

TABLE 25
Detailed Optical Data of Each Lens in Example 9

| | | | | Material | |
|---|---|---|---|---|---|
| Surface | Surface | Curvature | Thick- | (refractive index/ | Conic |
| number | type | radius | ness | Abbe number) | coefficient |
| OBJ | Spherical | Infinite | Infinite | | |
| S1 | Aspheric | 3.5808 | 0.9125 | 1.55/56.1 | −0.4843 |
| S2 | Aspheric | 16.0055 | 0.4898 | | −26.0897 |
| STO | Spherical | Infinite | 0.0300 | | |
| S3 | Aspheric | 50.0000 | 0.3000 | 1.64/23.5 | −99.0000 |
| S4 | Aspheric | 4.0254 | 0.2013 | | −7.0532 |
| S5 | Aspheric | 2.7750 | 1.4239 | 1.55/56.1 | −3.8147 |
| S6 | Aspheric | −50.0000 | 1.5251 | | −99.0000 |
| S7 | Aspheric | 14.7000 | 1.1123 | 1.64/23.5 | −98.9523 |
| S8 | Aspheric | 12.7000 | 0.6559 | | −109.6155 |
| S9 | Aspheric | −36.6721 | 0.5365 | 1.55/56.1 | 3.9726 |
| S10 | Aspheric | 3.5459 | 0.1126 | | −4.6272 |
| S11 | Spherical | Infinite | 0.2100 | 1.52/64.2 | |
| S12 | Spherical | Infinite | 0.4960 | | |
| S13 | Spherical | Infinite | | | |

Table 26 shows high-order coefficients that may be used for each aspheric surface of each aspheric lens in the example.

TABLE 26
High-Order Coefficients of Each Aspheric Surface in Example 9

| Surface | | | | | | | | | |
|---|---|---|---|---|---|---|---|---|---|
| number | A4 | A6 | A8 | A10 | A12 | A14 | A16 | A18 | A20 |
| S1 | −8.4109E−04 | 1.7838E−04 | −9.8310E−04 | 6.6876E−04 | −2.8450E−04 | 8.0411E−05 | −1.3307E−05 | 1.2252E−08 | −4.7722E−08 |
| S2 | 8.5541E−03 | −4.5625E−03 | 6.0472E−04 | 1.2845E−04 | −1.0914E−04 | 3.2275E−05 | −5.0131E−06 | 4.0684E−07 | −1.3480E−08 |
| S3 | 4.3773E−02 | −3.3864E−02 | 2.0238E−02 | −9.4084E−03 | 3.0568E−03 | −6.8258E−04 | 9.1531E−05 | −7.2799E−08 | 2.5170E−07 |
| S4 | 3.8148E−02 | −2.8227E−02 | 2.1386E−02 | −1.0806E−02 | 3.5555E−03 | −7.6808E−04 | 1.0642E−04 | −8.8948E−08 | 3.1780E−07 |
| S5 | −1.3885E−04 | 2.0862E−03 | 4.1347E−04 | 2.2483E−04 | −5.7114E−04 | 3.1082E−04 | −8.3190E−05 | 1.1500E−05 | 6.6175E−07 |
| S8 | −1.2081E−02 | −6.9170E−04 | 1.7278E−03 | −1.6434E−03 | 8.7488E−04 | −3.0681E−04 | 6.4112E−06 | −7.2497E−08 | 3.3262E−07 |
| S7 | −1.8940E−02 | −4.1306E−03 | 4.3872E−04 | −3.8348E−04 | 1.0866E−04 | −7.2348E−08 | 0.0000E+00 | 0.0000E+00 | 0.0000E+00 |
| S8 | −1.0629E−02 | −2.0001E−03 | −5.9081E−04 | 1.0114E−05 | 1.6706E−04 | −7.9785E−05 | 1.8337E−05 | −1.6853E−08 | 2.8214E−08 |
| S9 | −9.4929E−02 | 3.8667E−02 | −2.5760E−02 | 1.6868E−02 | −8.0887E−03 | 3.3389E−03 | −7.6032E−04 | 9.7891E−05 | −5.5161E−06 |
| S10 | −8.3440E−02 | 4.2824E−02 | −2.1828E−02 | 9.0527E−03 | −2.7687E−03 | 5.7633E−04 | −7.8748E−06 | 6.8133E−08 | −1.9038E−07 |

Table 27 shows an effective focal length f of the optical imaging lens assembly in Example 9, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

TABLE 27
Parameters of the Optical Imaging Lens Assembly

| | | |
|---|---|---|
| TTL | (mm) | 8.01 |
| ImgH | (mm) | 2.83 |
| f | (mm) | 6.53 |
| f1 | (mm) | 8.24 |
| f2 | (mm) | −6.81 |
| f3 | (mm) | 4.86 |
| f4 | (mm) | −185.18 |
| f5 | (mm) | −5.89 |

Specific values of each conditional expression in the example refer to Table 34.

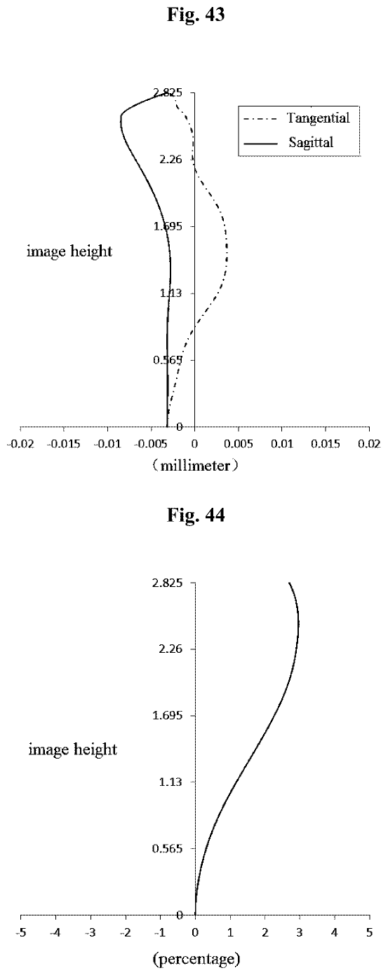

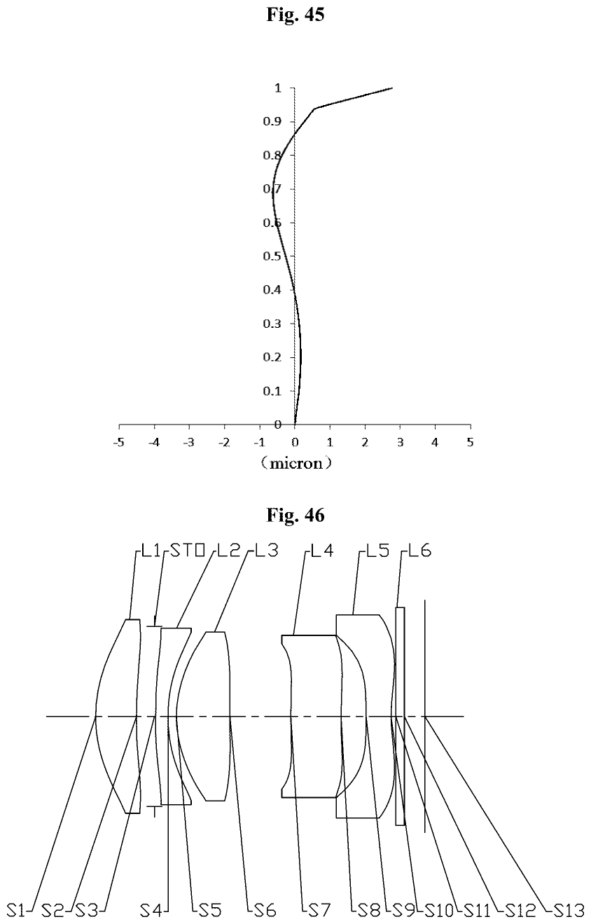

FIG. 42 shows a longitudinal aberration curve of the optical imaging lens assembly according to Example 9 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 43 shows an astigmatism curve of the optical imaging lens assembly according to Example 9 to represent a tangential image surface curvature and a sagittal image surface curvature. FIG. 44 shows a distortion curve of the optical imaging lens assembly according to Example 9 to represent distortion values corresponding to different fields of view. FIG. 45 shows a lateral color curve of the optical imaging lens assembly according to Example 9 to represent aberrations at different image heights on the imaging surface after the light passes through the optical imaging lens assembly. It can be seen from FIGS. 42-45 that the optical imaging lens assembly according to Example 9 is applicable to a portable electronic product and has a large aperture and high imaging quality.

### Example 10

As shown in FIG. 46, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a convex surface, and an image-side surface S4 of the second lens is a concave surface. The third lens L3 has a positive refractive power, an object-side surface S5 of the third lens is a convex surface, and an image-side surface S6 of the third lens is a concave surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 28 shows a surface type, curvature radius, thickness, material and conic coefficient of each lens of the optical imaging lens assembly according to Example 10, wherein the units of the curvature radius and the thickness are all millimeters.

TABLE 28
Delated Optical Data of Each Lens in Example 10

| | | | | Material | |
|---|---|---|---|---|---|
| Surface | Surface | Curvature | Thick- | (refractive index/ | Conic |
| number | type | radius | ness | Abbe number) | coefficient |
| OBJ | Spherical | Infinite | Infinite | | |
| S1 | Aspheric | 3.4311 | 0.9924 | 1.55/56.1 | −0.4610 |
| S2 | Aspheric | 13.8827 | 0.4384 | | −35.2235 |
| STO | Spherical | Infinite | 0.0300 | | |
| S3 | Aspheric | 45.6024 | 0.3000 | 1.64/23.5 | −41.9787 |
| S4 | Aspheric | 4.0289 | 0.2012 | | −7.2125 |
| S5 | Aspheric | 2.6400 | 1.3049 | 1.55/56.1 | −3.5916 |
| S6 | Aspheric | 50.0000 | 1.4808 | | 5.2413 |
| S7 | Aspheric | 14.3112 | 1.2206 | 1.64/23.5 | −77.2444 |
| S8 | Aspheric | 12.3112 | 0.6104 | | −65.5579 |
| S9 | Aspheric | −50.0000 | 0.6047 | 1.55/56.1 | −99.0000 |
| S10 | Aspheric | 3.7553 | 0.1165 | | −2.8595 |
| S11 | Spherical | Infinite | 0.2100 | 1.52/64.2 | |
| S12 | Spherical | Infinite | 0.4970 | | |
| S13 | Spherical | Infinite | | | |

Table 29 shows high-order coefficients that may be used for each aspheric surface of each aspheric lens in the example.

TABLE 29
High-Order Coefficients of Each Aspheric Surface in Example 10

| Surface | | | | | | | | | |
|---|---|---|---|---|---|---|---|---|---|
| number | A4 | A6 | A8 | A10 | A12 | A14 | A16 | A18 | A20 |
| S1 | −6.1296E−04 | 1.3707E−04 | −8.7010E−04 | 6.0764E−04 | −2.8718E−04 | 7.2121E−05 | −1.1841E−06 | 1.0852E−08 | −4.2240E−08 |
| S2 | 8.9048E−03 | −4.9486E−03 | 3.5758E−04 | 5.2286E−04 | −3.2023E−04 | 9.3379E−05 | −1.5183E−05 | 1.3188E−08 | −4.8083E−08 |
| S3 | 4.4190E−02 | −3.4644E−02 | 2.0020E−02 | −8.6717E−03 | 2.5354E−03 | −4.7813E−04 | 5.5640E−05 | −3.6288E−05 | 1.0001E−07 |
| S4 | 3.7806E−02 | −2.3632E−02 | 2.0203E−02 | −9.2596E−03 | 2.4820E−03 | −3.5444E−04 | 1.6860E−05 | 1.4827E−06 | −1.5500E−07 |
| S5 | −1.4898E−04 | 2.4252E−03 | 5.1056E−04 | −1.6137E−05 | −4.1519E−04 | 2.5219E−04 | −6.8643E−06 | 5.7842E−06 | −5.7381E−07 |
| S8 | −1.1900E−02 | −4.8496E−04 | 1.4458E−03 | −1.2808E−03 | 7.5158E−04 | −2.7778E−04 | 6.1806E−05 | −7.4802E−06 | 3.6481E−07 |
| S7 | −1.7870E−02 | −4.3023E−03 | 4.6368E−04 | −4.2796E−04 | 1.0518E−04 | −5.0091E−06 | 0.0000E+00 | 0.0000E+00 | 0.0000E+00 |
| S8 | −1.0378E−02 | −4.3335E−04 | −2.3103E−03 | 1.8161E−03 | −1.1242E−03 | 4.8443E−04 | −1.3034E−04 | 2.0062E−05 | −1.3198E−06 |
| S9 | −7.9636E−02 | 2.9088E−02 | −1.8261E−02 | 1.2128E−02 | −6.6628E−03 | 2.4616E−03 | −5.6272E−04 | 7.4800E−05 | −4.3881E−06 |
| S10 | −7.3236E−02 | 3.1132E−02 | −1.4610E−02 | 5.8252E−03 | −1.7858E−03 | 3.8931E−04 | −4.8650E−05 | 3.8725E−08 | −1.1897E−07 |

Table 30 shows an effective focal length f of the optical imaging lens assembly in Example 10, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

Parameters of the Optical Imaging Lens A

| | | |
|---|---|---|
| TTL | (mm) | 8.01 |
| ImgH | (mm) | 2.83 |
| f | (mm) | 6.58 |
| f1 | (mm) | 8.08 |
| f2 | (mm) | −6.88 |
| f3 | (mm) | 5.06 |
| f4 | (mm) | −179.64 |
| f5 | (mm) | −6.37 |

Specific values of each conditional expression in the example refer to Table 34.

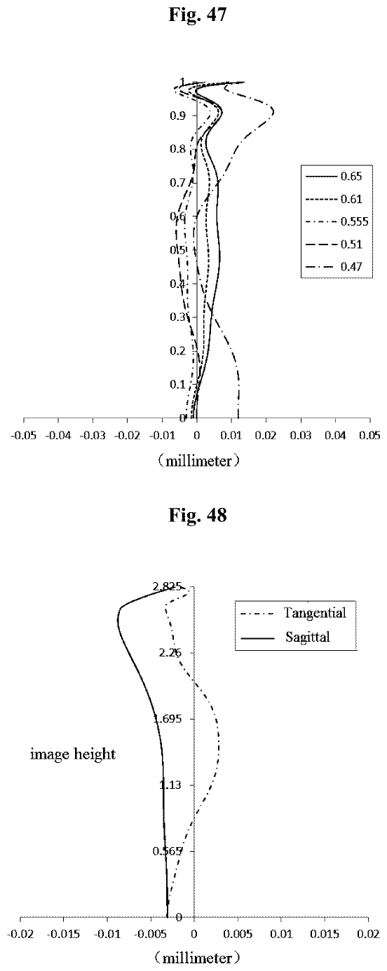

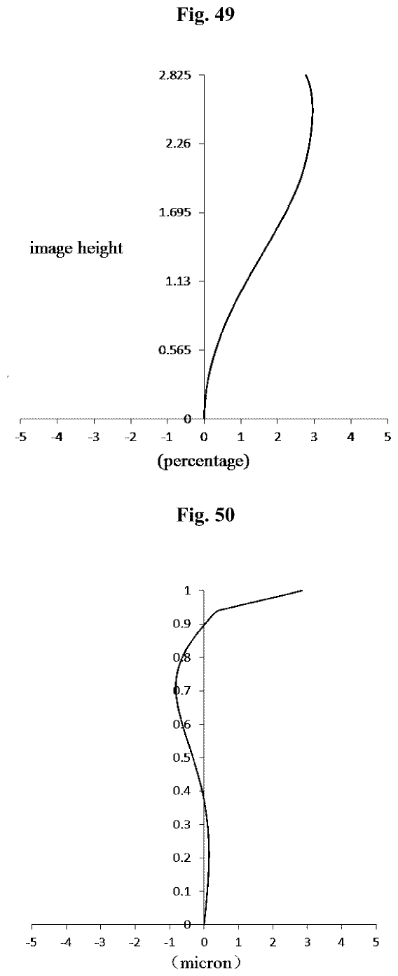

FIG. 47 shows a longitudinal aberration curve of the optical imaging lens assembly according to Example 10 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 48 shows an astigmatism curve of the optical imaging lens assembly according to Example 10 to represent a tangential image surface curvature and a sagittal image surface curvature. FIG. 49 shows a distortion curve of the optical imaging lens assembly according to Example 10 to represent distortion values corresponding to different fields of view. FIG. 50 shows a lateral color curve of the optical imaging lens assembly according to Example 10 to represent aberrations at different image heights on the imaging surface after the light passes through the optical imaging lens assembly. It can be seen from FIGS. 47-50 that the optical imaging lens assembly according to Example 10 is applicable to a portable electronic product and has a large aperture and high imaging quality.

### Example 11

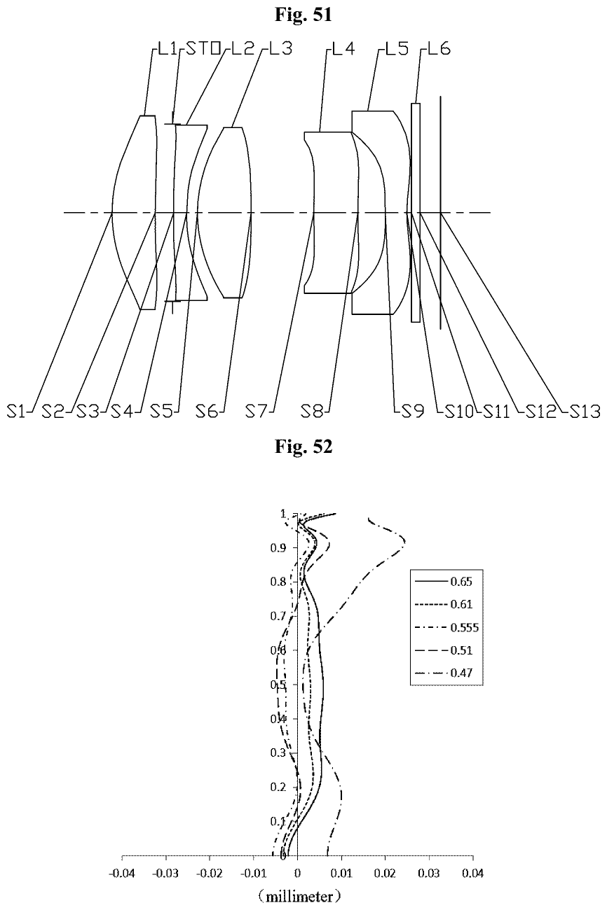

As shown in FIG. 51, the optical imaging lens assembly sequentially includes from an object side to an image side along an optical axis: a first lens L1, a diaphragm STO, a second lens L2, a third lens L3, a fourth lens L4, a fifth lens L5, an optical filter L6 and an imaging surface S13.

The first lens L1 has a positive refractive power, an object-side surface S1 of the first lens is a convex surface, and an image-side surface S2 of the first lens is a concave surface. The second lens L2 has a negative refractive power, an object-side surface S3 of the second lens is a concave surface, and an image-side surface S4 of the second lens is a concave surface. The third lens L3 has a positive refractive power, an object-side surface S5 of the third lens is a convex surface, and an image-side surface S6 of the third lens is a convex surface. The fourth lens L4 has a negative refractive power, an object-side surface S7 of the fourth lens is a convex surface, and an image-side surface S8 of the fourth lens is a concave surface. The fifth lens L5 has a negative refractive power, an object-side surface S9 of the fifth lens is a concave surface, and an image-side surface S10 of the fifth lens is a concave surface. The optical filter L6 has an object-side surface S11 of the optical filter and an image-side surface S12 of the optical filter. Light from an object sequentially penetrates through each surface, and is finally imaged on the imaging surface S13. Table 31 shows a surface type, curvature radius, thickness, material and conic coefficient of each lens of the optical imaging lens assembly according to Example 11, wherein the units of the curvature radius and the thickness are all millimeters.

TABLE 31
Detailed Optical Data of Each Lens in Example 11

| | | | | Material | |
|---|---|---|---|---|---|
| Surface | Surface | Curvature | Thick− | (refactive index/ | Conic |
| number | type | radius | ness | Abbe number) | coefficient |
| OBJ | Spherical | Infinite | Infinite | | |
| S1 | Aspheric | 3.6096 | 1.0487 | 1.55/56.1 | −0.4637 |
| S2 | Aspheric | 35.9858 | 0.4215 | | −40.4891 |
| STO | Spherical | Infinite | 0.0300 | | |
| S3 | Aspheric | −50.0000 | 0.3139 | 1.64/23.5 | −31.0487 |
| S4 | Aspheric | 4.9229 | 0.2610 | | −7.9413 |
| S5 | Aspheric | 3.1124 | 1.3045 | 1.55/56.1 | −3.8525 |
| S6 | Aspheric | −45.3539 | 1.5270 | | −99.0000 |
| S7 | Aspheric | 14.7000 | 1.0700 | 1.64/23.5 | −99.0000 |
| S8 | Aspheric | 12.7000 | 0.6669 | | −125.9036 |
| S9 | Aspheric | −36.9417 | 0.5252 | 1.55/56.1 | 34.0576 |
| S10 | Aspheric | 3.4782 | 0.1105 | | −4.9686 |
| S11 | Spherical | Infinite | 0.2100 | 1.52/64.2 | |
| S12 | Spherical | Infinite | 0.4970 | | |
| S13 | Spherical | infinite | | | |

Table 32 shows high-order coefficients that may be used for each aspheric surface of each aspheric lens in the example.

TABLE 32
High-Order Coefficients of Each Aspheric Surface in Example 11

| Surface | | | | | | | | | |
|---|---|---|---|---|---|---|---|---|---|
| number | A4 | A6 | A8 | A10 | A12 | A14 | A16 | A18 | A20 |
| S1 | − [symbol] .1533E−04 | 4.3780E−04 | −1.1447E−02 | 7.8998E−04 | −3.4487E−04 | 9.2978E−05 | −1.5234E−06 | 1.3888E−08 | −5.3832E−08 |
| S2 | 8.9075E−03 | −5.3630E−03 | 1.1402E−03 | −2.2864E−05 | −1.1023E−04 | 4.4950E−05 | −8.5726E−08 | 8.3674E−07 | −3.3597E−08 |
| S3 | 4.3766E−02 | −3.4005E−02 | 2.0727E−02 | −9.8182E−03 | 3.2097E−03 | −6.9649E−04 | 8.6627E−05 | −7.7714E−06 | 2.7557E−07 |
| S4 | 3.8812E−02 | −2.8417E−02 | 2.1168E−02 | −1.0711E−02 | 3.4072E−03 | −6.7764E−04 | 8.1321E−05 | −6.3486E−06 | 1.4145E−07 |
| S5 | −5.5429E−05 | 2.1302E−03 | −1.0718E−04 | 9.8127E−04 | −1.0965E−03 | 5.2832E−04 | −1.3598E−04 | 1.8605E−05 | −1.0676E−08 |
| S8 | −1.2005E−02 | −7.7372E−04 | 2.5652E−03 | −2.3881E−03 | 1.3882E−03 | −5.0022E−04 | 1.0818E−04 | −1.2732E−05 | 6.1547E−07 |
| S7 | −1.9878E−02 | −4.3490E−03 | 7.7555E−04 | −5.5861E−04 | 1.5455E−04 | −1.1780E−05 | 0.0000E+00 | 0.0000E+00 | 0.0000E−00 |
| S8 | −1.1968E−02 | −1.1492E−03 | −2.1789E−03 | 1.6129E−03 | −8.0596E−04 | 2.9188E−04 | −8.9748E−05 | 1.0143E−05 | 6.4908E−07 |
| S9 | −1.0238E−01 | 4.5755E−02 | −3.0848E−02 | 2.0026E−02 | −1.0678E−02 | 3.8269E−03 | 9.0715E−04 | 1.1924E−04 | −8.8232E−08 |
| S10 | −8.9383E−02 | 4.8961E−02 | −2.8314E−02 | 1.1083E−02 | −3.3860E−02 | 7.0989E−04 | 8.4630E−06 | 7.1824E−08 | −2.3710E−07 |

[symbol]

indicates data missing or illegible when filed

Table 33 shows an effective focal length f of the optical imaging lens assembly in Example 11, effective focal lengths f1 to f5 of each lens, a distance TTL from the object-side surface S1 to the imaging surface S13 and ImgH, wherein ImgH is a half of a diagonal length of an effective pixel region on the imaging surface of the optical imaging lens assembly.

Parameters of the Optical Imaging Lens A

| | | |
|---|---|---|
| TTL | (mm) | 7.99 |
| ImgH | (mm) | 2.83 |
| f | (mm) | 6.53 |
| f₁ | (mm) | 7.27 |
| f₂ | (mm) | −6.94 |
| f₃ | (mm) | 5.39 |
| f₄ | (mm) | −183.24 |
| f₅ | (mm) | −5.80 |

Specific values of each conditional expression in the example refer to Table 34.

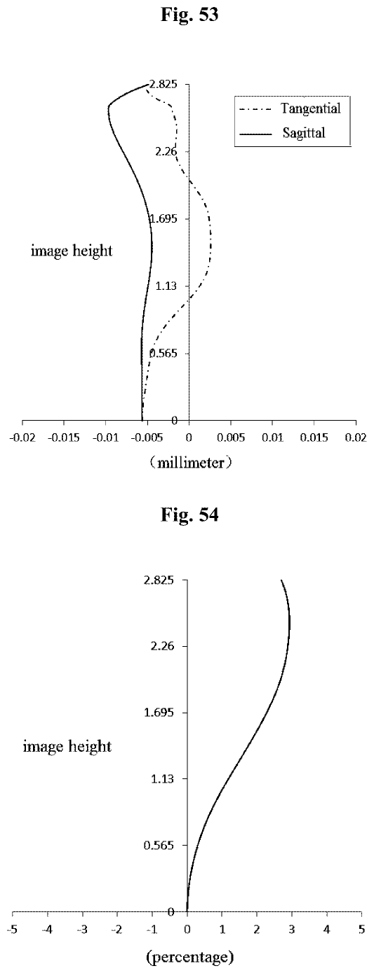

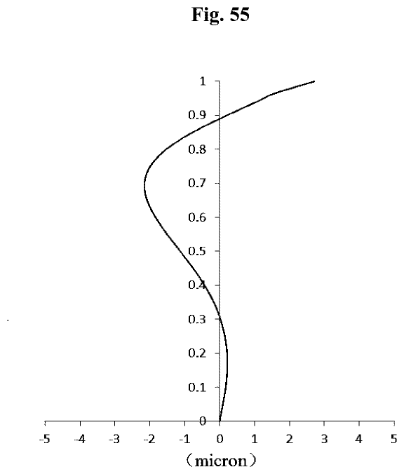

FIG. 52 shows a longitudinal aberration curve of the optical imaging lens assembly according to Example 11 to represent deviations of a convergence focal point after light with different wavelengths passes through the optical imaging lens assembly, such that image focal surfaces of the light with different wavelengths do not overlap during final imaging and polychromatic light is diverged to form chromatic dispersions. FIG. 53 shows an astigmatism curve of the optical imaging lens assembly according to Example 11 to represent a tangential image surface curvature and a sagittal image surface curvature. FIG. 54 shows a distortion curve of the optical imaging lens assembly according to Example 11 to represent distortion values corresponding to different fields of view. FIG. 55 shows a lateral color curve of the optical imaging lens assembly according to Example 11 to represent aberrations at different image heights on the imaging surface after the light passes through the optical imaging lens assembly. It can be seen from FIGS. 52-55 that the optical imaging lens assembly according to Example 11 is applicable to a portable electronic product and has a large aperture and high imaging quality.

TABLE 34
Specific Values of Each Conditional Expression in Example 1 to Example 11

| Conditional | | | | | | | | | | | |
|---|---|---|---|---|---|---|---|---|---|---|---|
| expression/ | | | | | | | | | | | |
| example | 1 | 2 | 3 | 4 | 5 | 6 | 7 | 8 | 9 | 10 | 11 |
| TTL/EPD | 1.70 | 1.78 | 1.73 | 1.72 | 1.72 | 1.70 | 1.71 | 1.73 | 1.72 | 1.71 | 1.71 |
| f1/f | 1.16 | 1.40 | 1.37 | 1.33 | 1.01 | 1.13 | 1.29 | 1.28 | 1.26 | 1.23 | 1.11 |
| f123/f45 | −0.81 | −0.77 | −0.75 | −0.95 | −0.97 | −0.91 | −0.91 | −0.98 | −1.01 | −0.95 | −1.02 |
| (R4 + R5)/(R4 − R5) | 3.27 | 4.35 | 4.29 | 5.24 | 3.96 | 3.57 | 4.88 | 5.48 | 5.44 | 4.80 | 4.44 |
| R7/R8 | 1.09 | 1.15 | 1.11 | 1.13 | 0.93 | 0.82 | 0.76 | 0.93 | 1.16 | 1.16 | 1.16 |
| T34/TD | 0.24 | 0.21 | 0.22 | 0.22 | 0.23 | 0.22 | 0.22 | 0.21 | 0.21 | 0.21 | 0.21 |
| BFL/TTL | 0.11 | 0.11 | 0.11 | 0.11 | 0.10 | 0.10 | 0.10 | 0.10 | 0.10 | 0.10 | 0.10 |
| T12/T23 | 2.08 | 3.26 | 3.50 | 2.67 | 1.82 | 1.63 | 2.91 | 2.75 | 2.58 | 2.33 | 1.73 |
| SAG41/CT4 | −0.07 | −0.04 | −0 05 | −0.15 | −0.17 | −0.17 | −0.17 | −0.18 | −0.19 | −0.18 | −0.21 |
| ET4/ET5 | 1.26 | 1.32 | 1.49 | 1.45 | 1.23 | 1.16 | 1.16 | 1.08 | 1.19 | 1.25 | 1.13 |
| SAG51/T45 | −0.91 | −0.85 | −0.89 | −1.03 | −1.08 | −0.94 | −1.05 | −1.17 | −1.19 | −1.19 | −1.21 |
| SAG31/CT3 | 0.59 | 0.54 | 0.59 | 0.50 | 0.49 | 0.56 | 0.57 | 0.49 | 0.48 | 0.55 | 0.49 |
| DT52/ImgH | 0.88 | 0.88 | 0.90 | 0.87 | 0.87 | 0.87 | 0.87 | 0.88 | 0.88 | 0.88 | 0.87 |
| DT12/DT41 | 1.23 | 1.30 | 1.28 | 1.28 | 1.29 | 1.29 | 1.29 | 1.29 | 1.30 | 1.30 | 1.30 |
| f3/f | 0.88 | 0.72 | 0.76 | 0.73 | / | 0.83 | 0.70 | 0.73 | 0.75 | 0.77 | 0.82 |

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure

What is claimed is:

1. An optical imaging lens assembly, sequentially comprising from an object side to an image side along an optical axis:
a first lens with a refractive power;
a second lens with a refractive power, an image-side surface of the second lens is a concave surface;
a third lens with a positive refractive power, an object-side surface of the third lens is a convex surface;
a fourth lens with a refractive power; and
a fifth lens with a refractive power,
wherein TTL is a distance from an object-side surface of the first lens to an imaging surface of the optical imaging lens assembly on the optical axis, EPD is an Entrance Pupil Diameter of the optical imaging lens assembly, and TTL and EPD satisfy TTL/EPD<2.

2. The optical imaging lens assembly according to claim 1, wherein an effective focal length f1 of the first lens and an effective focal length f of the optical imaging lens assembly satisfy 1<f1/f<1.5.

3. The optical imaging lens assembly according to claim 1, wherein BFL is a distance from an image-side surface of the fifth lens to the imaging surface of the optical imaging lens assembly on the optical axis, and BFL and TTL satisfy BFL/TTL<0.12.

4. The optical imaging lens assembly according to claim 1, wherein a curvature radius R4 of the image-side surface of the second lens and a curvature radius R5 of the object-side surface of the third lens satisfy 3<(R4+R5)/(R4−R5)<6.

5. The optical imaging lens assembly according to claim 1, wherein a curvature radius R7 of an object-side surface of the fourth lens and a curvature radius R8 of an image-side surface of the fourth lens satisfy 0.7<R7/R8<1.2.

6. The optical imaging lens assembly according to claim 1, wherein T34 is a distance between the third lens and the fourth lens on the optical axis, TD is a distance from an object-side surface of the first lens to an image-side surface of the fifth lens on the optical axis, and T34 and TD satisfy 0.2<T34/TD<0.3.

7. The optical imaging lens assembly according to claim 1, wherein T12 is a distance between the first lens and the second lens on the optical axis, T23 is a distance between the second lens and the third lens on the optical axis, and T12 and T23 satisfy 1.5<T12/T23<3.6.

8. The optical imaging lens assembly according to claim 1, wherein SAG41 is an on-axis distance from an intersection point of an object-side surface of the fourth lens and the optical axis to an effective radius vertex of the object-side surface of the fourth lens, and SAG41 and a center thickness CT4 of the fourth lens on the optical axis satisfy −0.25<SAG41/CT4<0.

9. The optical imaging lens assembly according to claim 1, wherein an edge thickness ET4 of the fourth lens and an edge thickness ET5 of the fifth lens satisfy 1<ET4/ET5<1.5.

10. The optical imaging lens assembly according to claim 1, wherein SAG51 is an on-axis distance from an intersection point of an object-side surface of the fifth lens and the optical axis to an effective radius vertex of the object-side surface of the fifth lens, T45 is a distance between the fourth lens and the fifth lens on the optical axis, and SAG51 and T45 satisfy −1.3<SAG51/T45<−0.8.

11. The optical imaging lens assembly according to claim 1, wherein SAG31 is an on-axis distance from an intersection point of the object-side surface of the third lens and the optical axis to an effective radius vertex of the object-side surface of the third lens, and SAG31 and a center thickness CT3 of the third lens on the optical axis satisfy 0.3<SAG31/CT3<0.7.

12. The optical imaging lens assembly according to claim 1, wherein an effective focal length f3 of the third lens and an effective focal length f of the optical imaging lens assembly satisfy 0.5<f3/f<1.

13. The optical imaging lens assembly according to claim 1, wherein DT52 is an effective radius of an image-side surface of the fifth lens, ImgH is a half of a diagonal length of an effective pixel region on the imaging surface, and DT52 and ImgH satisfy 0.8<DT52/ImgH<1.

14. The optical imaging lens assembly according to claim 1, wherein DT12 is an effective radius of an image-side surface of the first lens, DT41 is an effective radius of an object-side surface of the fourth lens, and DT12 and DT41 satisfy 1<DT12/DT41<1.5.

15. An optical imaging lens assembly, sequentially comprising from an object side to an image side along an optical axis:
a first lens with a refractive power;
a second lens with a refractive power, an image-side surface of the second lens is a concave surface;
a third lens with a positive refractive power, an object-side surface of the third lens is a convex surface;
a fourth lens with a refractive power; and
a fifth lens with a refractive power,
wherein f123 is a combined focal length of the first lens, the second lens and the third lens, f45 is a combined focal length of the fourth lens and the fifth lens, and f123 and f45 satisfy −1.2<f123/f45<−0.7.

16. The optical imaging lens assembly according to claim 15, wherein TTL is a distance from an object-side surface of the first lens to an imaging surface on the optical axis, EPD is an Entrance Pupil Diameter of the optical imaging lens assembly, and TTL and EPD satisfy TTL/EPD<2.

17. The optical imaging lens assembly according to claim 15, wherein an effective focal length f1 of the first lens and an effective focal length f of the optical imaging lens assembly satisfy 1<f1/f<1.5.

18. The optical imaging lens assembly according to claim 15, wherein BFL is a distance from an image-side surface of the fifth lens to an imaging surface on the optical axis, TTL is a distance from an object-side surface of the first lens to the imaging surface of the optical imaging lens assembly on the optical axis, and BFL and TTL satisfy BFL/TTL<0.12.

19. The optical imaging lens assembly according to claim 15, wherein a curvature radius R4 of the image-side surface of the second lens and a curvature radius R5 of the object-side surface of the third lens satisfy 3<(R4+R5)/(R4−R5)<6.

20. The optical imaging lens assembly according to claim 15, wherein a curvature radius R7 of an object-side surface of the fourth lens and a curvature radius R8 of an image-side surface of the fourth lens satisfy 0.7<R7/R8<1.2.

21. (canceled)

22. (canceled)

23. (canceled)

24. (canceled)

25. (canceled)

26. (canceled)

27. (canceled)

28. (canceled)

29. (canceled)
